(19) United States
(12) Patent Application Publication
(10) Pub. No.: US 2007/0025550 A1
(43) Pub. Date: Feb. 1, 2007

(54) Security value estimating apparatus, security value estimating method, and computer-readable recording medium for estimating security value

(76) Inventor: Atsuhisa Saitoh, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/491,906

(22) Filed: Jul. 25, 2006

(30) Foreign Application Priority Data
Jul. 26, 2005 (JP) 2005-216004

(51) Int. Cl. H04K 3/00

(52) U.S. Cl. 380/1

(57) ABSTRACT

A security value estimating apparatus for estimating a security value of an unregistered data item includes a primary data generating part for generating various types of primary data based on the unregistered data item, a data amount calculating part for calculating the value of the data amount of each type of the primary data, a similarity degree calculating part for calculating a degree of similarity of the primary data with respect to various types of secondary data that are generated based on a registered data item, a security value estimating part for estimating the security value of the unregistered data item by selecting a secondary data item from the secondary data based on the value of the data amount calculated by the data amount calculating part and the degree of similarity calculated by the similarity degree calculating part and applying the security value corresponding to the selected secondary data item.

### BACKGROUND OF THE INVENTION

1. Field of the Invention

The present invention relates to a security value estimating apparatus, a security value estimating method, and a computer-readable recording medium for estimating security value, and more particularly to a security value estimating apparatus, a security value estimating method, and a computer-readable recording medium, for example, for estimating the security value of an unregistered data item based on registered data.

2. Description of the Related Art

In the past, “security” was generally considered as security against threats or attacks from the outside, such as viruses. However, in recent years, the leakage of security data (e.g. customer data, personal data, private data) from the inside is considered to be a significant threat for companies and individuals. The problem of information leakage cannot be sufficiently prevented by merely using, for example, firewalls for blocking the exits of data. The countermeasures taken against this problem should be determined according to, for example, the value or the usage of data resources.

For example, companies, in general, create, store, and use their data resources in the form of documents. It is, therefore, important to determine the confidentiality of the documents and control the handling of the documents depending on its degree of confidentiality. Various technologies have been introduced for controlling the handling of such documents. For example, Japanese Laid-Open Patent Application No. 6-4530 (hereinafter referred to as “Patent Document 1”) discloses a technology in which each user is assigned with an ACL (Access Control List) indicating what kind of access is authorized to each user. By operating the system in accordance with the ACL, confidentiality of documents can be maintained. Although this technology may be able to maintain confidentiality inside the system, this technology is unable to maintain confidentiality in a case where a user having authorized access carries the confidential document outside of the system.

In another example, Japanese Laid-Open Patent Application No. 2001-273285 (hereinafter referred to as “Patent Document 2”) discloses a technology in which various tag attributes are embedded into an XML (extensible Markup Language) document, such as encrypting a code, designating an expiration date, or writing the group having authorized access. With this technology, even where the XML document is carried outside the system, access to the XML document can be controlled.

In yet another example, Japanese Laid-Open Patent Application No. 2002-342060 (hereinafter referred to as “Patent Document 3”) discloses a technology in which documents are converted into printable data and printing-prohibited data and are managed in correspondence with the printable data and printing-prohibited data. Accordingly, when a client requests browsing of a document, the printing-prohibited data corresponding to the document is transmitted to the client, and when a client requests printing of a document, the printable data corresponding to the document is transmitted to, for example, the printer of the client. In other words, by preparing data corresponding to various-access requests, data requiring access authority above a certain level can be prevented from leaking.

However, the technologies disclosed in the above-described Patent Documents 1, 2, and 3 require the user to perform a defining process or a preliminary setting process on the data. For example, with the technology of Patent Document 1, access control cannot be achieved unless the ACL is prepared beforehand. With the technology of Patent Document 2, a document cannot be controlled unless data for restricting access is embedded in the document. With the technology of Patent Document 3, access control cannot be achieved unless multiple files for storing data in correspondence with the various access requests are to be prepared beforehand.

In other words, access control using conventional technology can only be achieved where security data (e.g. access authorization) is assigned to data resources based on the determination of the user (e.g. determining authorization access, degree of confidentiality of the document). Furthermore, the access control may only be effective inside of the system (as in Patent Document 1) or effective only to data prepared beforehand in the system. For example, in a case of handling a document (e.g. unregistered document) that has not yet been subject to the determination by the user or in a case where a document that lacks data corresponding to the determination, access cannot be sufficiently controlled.

### SUMMARY OF THE INVENTION

The present invention may provide a security value estimating apparatus, a security value estimating method, and a computer-readable recording medium for estimating security value that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a security value estimating apparatus, a security value estimating method, and a computer-readable recording medium for estimating security value particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a security value estimating apparatus for estimating a security value of an unregistered data item, the security value estimating apparatus including: a primary data generating part for generating various types of primary data based on the unregistered data item; a data amount calculating part for calculating the value of the data amount of each type of the primary data; a similarity degree calculating part for calculating a degree of similarity of the primary data with respect to various types of secondary data that are generated based on a registered data item; and a security value estimating part for estimating the security value of the unregistered data item by selecting a secondary data item from the secondary data based on the value of the data amount calculated by the data amount calculating part and the degree of similarity calculated by the similarity degree calculating part and applying the security value corresponding to the selected secondary data item.

Another embodiment of the present invention provides a security value estimating method for estimating a security value of an unregistered data item, the security value estimating method including the steps of: a) generating various types of primary data based on the unregistered data item; b) calculating the value of the data amount of each type of the primary data; c) calculating the degree of similarity of the primary data with respect to various types of secondary data that are generated based on a registered data item; and d) estimating the security value of the unregistered data item by selecting a secondary data item from the secondary data based on the value of the data amount calculated in step b) and the degree of similarity calculated in step c) and applying the security value corresponding to the selected secondary data item.

Another embodiment of the present invention provides a computer-readable recording medium on which a program is recorded for causing a computer to execute a security value estimating method for estimating a security value of an unregistered data item, the security value estimating method including the steps of: a) generating various types of primary data based on the unregistered data item; b) calculating the value of the data amount of each type of the primary data; c) calculating the degree of similarity of the primary data with respect to various types of secondary data that are generated based on a registered data item; and d) estimating the security value of the unregistered data item by selecting a secondary data item from the secondary data based on the value of the data amount calculated in step b) and the degree of similarity calculated in step c) and applying the security value corresponding to the selected secondary data item.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary configuration of a security management system according to a first embodiment of the present invention;

FIG. 2 is a schematic diagram showing function parts included in a security attribute estimating server according to the first embodiment of the present invention;

FIG. 3 is a schematic diagram showing an exemplary configuration of a data storing part according to the first embodiment of the present invention;

FIG. 4 is a schematic diagram showing an exemplary configuration of a security attribute estimating part according to the first embodiment of the present invention;

FIG. 5 is a schematic diagram showing an exemplary hardware configuration of a security attribute estimating server according to an embodiment of the present invention;

FIG. 6 is a sequence diagram for describing an operation of uploading document data and their security attribute values from a document server according to the first embodiment of the present invention;

FIG. 7 is an example of an ID data management table according to an embodiment of the present invention;

FIG. 8 is a sequence diagram for describing an operation of estimating the security attribute value of an unregistered data item (target data item) according to the first embodiment of the present invention;

FIG. 9 is an example of a coefficient table used for normalizing the data size of each type of data according to an embodiment of the present invention;

FIG. 10 is a flowchart for describing an operation of selecting selection data according to an embodiment of the present invention;

FIG. 11 is an example of a coefficient table used for normalizing the proportion of each data amount according to an embodiment of the present invention;

FIG. 12 is a schematic diagram showing an exemplary configuration of a security attribute estimating part according to a second embodiment of the present invention;

FIG. 13 is a sequence diagram for describing an operation of estimating the security attribute value of an unregistered data item (target data item) according to the second embodiment of the present invention;

FIG. 14 is an example of a table showing the unit values for each type of data according to an embodiment of the present invention;

FIG. 15 is a schematic diagram showing an exemplary configuration of a security management system according to the second embodiment of the present invention;

FIG. 16 is a schematic diagram showing an exemplary configuration of a security attribute estimating part according to the third embodiment of the present invention;

FIG. 17 is a sequence diagram for describing an operation of estimating the security attribute value of an unregistered data item (target data item) according to the third embodiment of the present invention;

FIG. 18 is a schematic diagram showing an exemplary configuration of a security management system according to the fourth embodiment of the present invention;

FIG. 19 is a schematic diagram showing an exemplary configuration of a security attribute estimating part according to the fourth embodiment of the present invention;

FIG. 20 is a sequence diagram for describing an operation of estimating the security attribute value of an unregistered data item (target data item) according to the fourth embodiment of the present invention;

FIG. 21 is a schematic diagram showing a security system including a security attribute estimating server according to an embodiment of the present invention; and

FIG. 22 is a flowchart for describing an operation a security system in a case where a document file is instructed to be printed according to an embodiment of the present invention.

### DESCRIPTION OF THE PREFERRED EMBODIMENTS

In the following, embodiments of the present invention will be described with reference to the accompanying drawings.

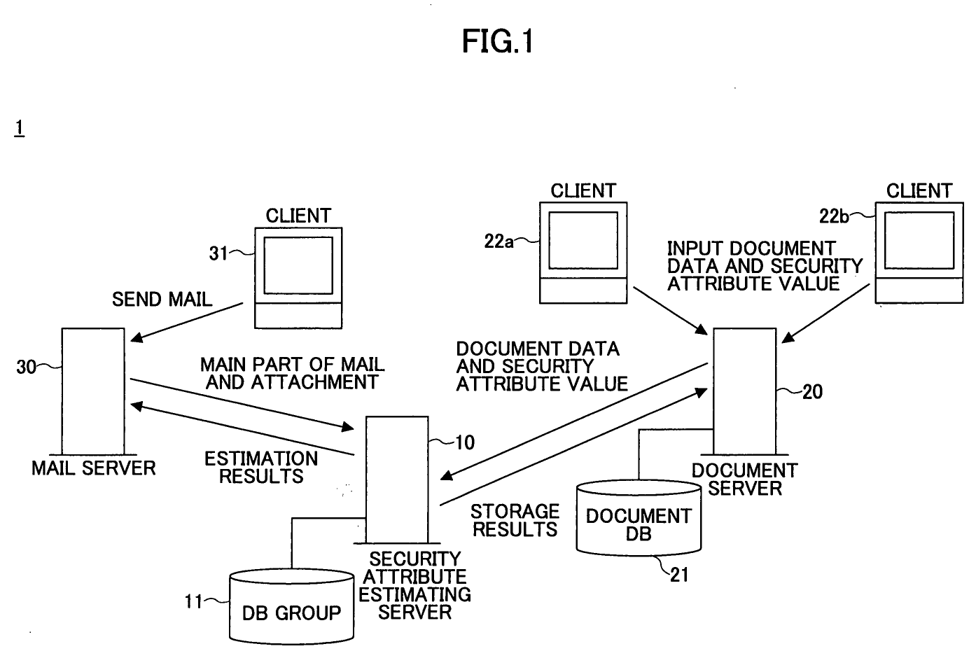

The security management system 1 shown in FIG. 1 includes, for example, a document server 20, a mail server 30, and a security attribute estimating server 10 that are connected by a network (via wire communication and/or wireless communication) such as LAN or the Internet. In this example, the document server 20, the mail server 30, and the security attribute estimating server 10 are located in a space where information confidentiality is to be maintained such as inside a company installation or inside an office.

The document server 20 together with one or more clients (client 22a, 22b) form a document management system. The document server 20 includes a document data DB (database) 21 that manages electronic documents (hereinafter referred to as “document data” or simply referred to as “documents”) uploaded from, for example, the clients 22a, 22b by associating the uploaded documents with various attribute values. The document server 20 transmits (uploads) document data and their associated attribute values regarding security attribute (hereinafter referred to as “security attribute value” or simply referred to as “security value”) to the security attribute estimating server 10. The document data and their security attribute values may be transmitted, for example, periodically or whenever a document is uploaded from the client 22a. The data format of the document is not to be limited in particular. That is, the data format of the document is not limited to a format used for word processor software, but also a format of other types of electronic data such as simple text data or image data. Furthermore, the documents may also include combinations of plural data formats (e.g. data attached with image data or audio data).

In this example, the term “security attribute” included in the various attributes associated to the documents refers to an attribute having an influence on security management. For example, the security attribute may be, for example, an attribute used for determining whether a target document is to be subjected to access control. More specifically, the security attribute includes, for example, the company position (e.g. division in a company, range of authority of a management supervisor), the type of document (e.g. personnel related document, accounting related document, project related document), the type of interested persons, the type of interested parties, the level of confidentiality (top secret (strict confidentiality), privileged information restricted to use within a company, a department, a group), the period for following a secrecy obligation (period for maintaining secrecy), a validity date (date when information loses validity) and a preservation period (obligated period (by law) for preserving a document).

Technologies of access control based on security attributes are disclosed more specifically in, for example, Japanese Laid-Open Patent Application Nos. 2004-094401, 2004-094405, 2004-102635, and 2004-102907. As shown in these publications, determining access control of documents is conducted by applying security attributes to security policies that are prepared beforehand. Accordingly, security attribute according to an embodiment of the present invention corresponds to security information.

The mail server 30 is for providing a mail service, for example, to a client 31. For example, in a case where the client 31 requests the mail server 30 to send electronic mail (mail document), the data of the main part (main text part) of the mail document and an attachment (attached document) attached to the mail document are transferred from the mail server 30 to the security attribute estimating server 10. The security attribute estimating server 10 serves to estimate the security values (security attribute values) of unregistered data having no security attribute value associated thereto such as the data of main part of the mail document and its attachment for enabling the mail server 30 to determine whether to send the mail document according to the security attribute value (security attribute estimation result) estimated by the security attribute estimating server 10. Thereby, unregistered date having no security value associated thereto (e.g. main part of mail, attachment) can be prevented from leaking. It is to be noted that the data format of the attached document attached to the mail document is not to be limited in particular.

The security attribute estimating server 10 stores various types of secondary data (various types of data generated (processed) from data originally sent from the clients 22a, 22b to the document server 20, for example, text data, image data, audio data) and the security attribute value associated to the secondary data (i.e. registered data) in a DB (database) group 11. The security attribute estimating server 10 compares the secondary data of the main text part of the mail document and its attachment attached to the mail document (i.e. unregistered data) with the various types of data (i.e. registered data) stored in the DB group 11. The security attribute estimating server 10 identifies the secondary data identical or similar to the secondary data of the main text part of the mail document and its attached document. Accordingly, the security attribute estimating server 10 estimates the security attribute value that is to be applied to the main text part and the attached document based on the security attribute values of the secondary data that are identical or similar to the secondary data of the main text part of the mail document and its attached document. The result of estimating the security attribute value (security attribute estimation result) is transmitted to the mail server 30. In other words, the security information (e.g. access authorization) set to the documents identical to or similar to the main text part and the attached document are applied to the main text part and the attached document so that the main text part and the attached document can be prevented from being unconditionally transmitted outside.

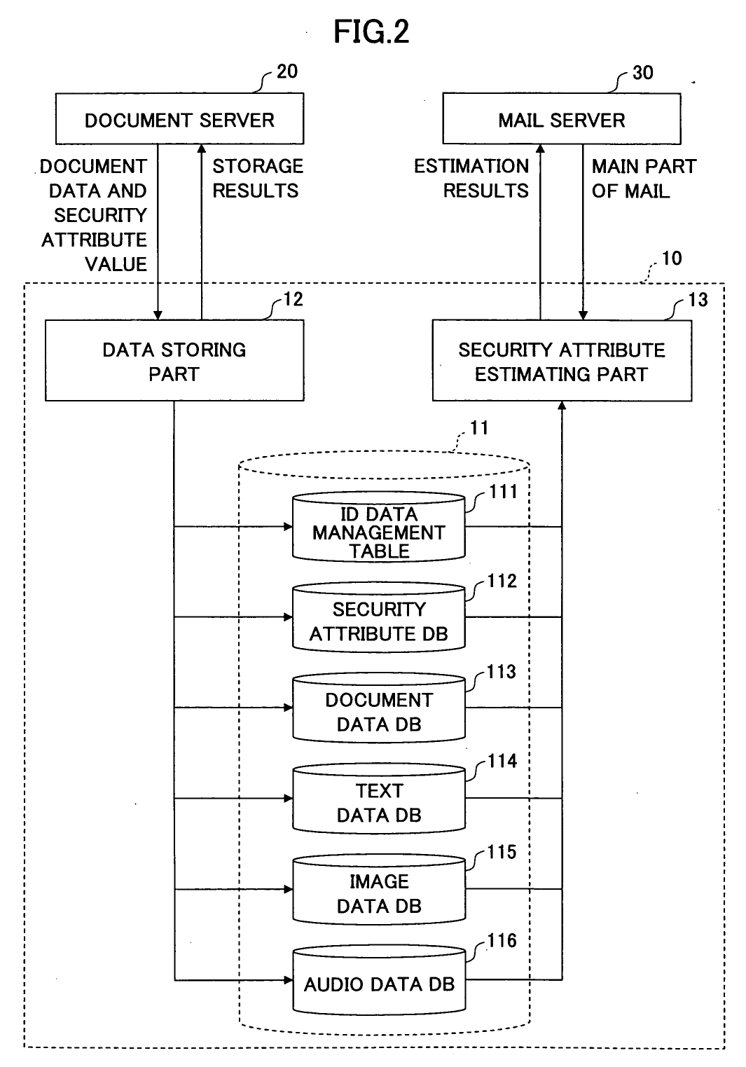

Next, the security attribute estimating server 10 is described in further detail. FIG. 2 is a schematic diagram showing an exemplary configuration of the functional parts of the security attribute estimating server 10 according to the first embodiment of the present invention. The security attribute estimating server 10 includes, for example, an data storing part 12, a security attribute estimating part 13, an ID information management table 111, a security attribute database (security attribute DB) 112, a document data database (document DB) 113, a text data database (text DB) 114, an image data database (image information DB), and an audio data database (audio information DB) 116. As shown in FIG. 2, the database group 11 comprises the ID information management table 111, the security attribute DB 112, the document data DB 113, the text data DB 114, the image data DB, and the audio data DB 116.

The data storing part 12 generates various types of secondary data (i.e. processed data) based on a target document transmitted from the document server 20. Then, the data storing part 12 registers the generated secondary data and the security attribute value (corresponding to the document transmitted from the document server 20) in a corresponding database of the DB group 11. The security attribute values are registered in the security attribute DB 112. The target document (primary data, i.e. document data that have not yet been processed, for example, a data conversion process), which are transmitted from the document server 20, are registered in the document DB 113. The text data, which are generated based on the target document, are registered in the text data DB 114. The image data, which are generated based on the target document, are registered in the image data DB 115. The audio data, which are extracted or synthesized from the target document, are registered in the audio data DB 116. The ID data management table 111 is for associating the data registered in the security attribute DB 112, the document data DB 113, the text data DB 114, the image data DB 115, and the audio data DB 116 together with the corresponding secondary information for each target document.

The security attribute estimating part 13 compares the main text part of the mail document and its attached document transmitted from the mail server 30 with the registered data stored in the DB group 11. By comparing the main text part and its attached document with the data stored in the DB group 11, the security attribute estimating part 13 identifies data identical or similar to the main text part and its attached document from the data stored in the DB group 11. Then, the security attribute estimating part 13 estimates the security attribute value to be applied to the main text part and its attached document based on the security attribute value of the identified data.

Next, the data storing part 12 and the security attribute estimating part 13 are described in further detail.

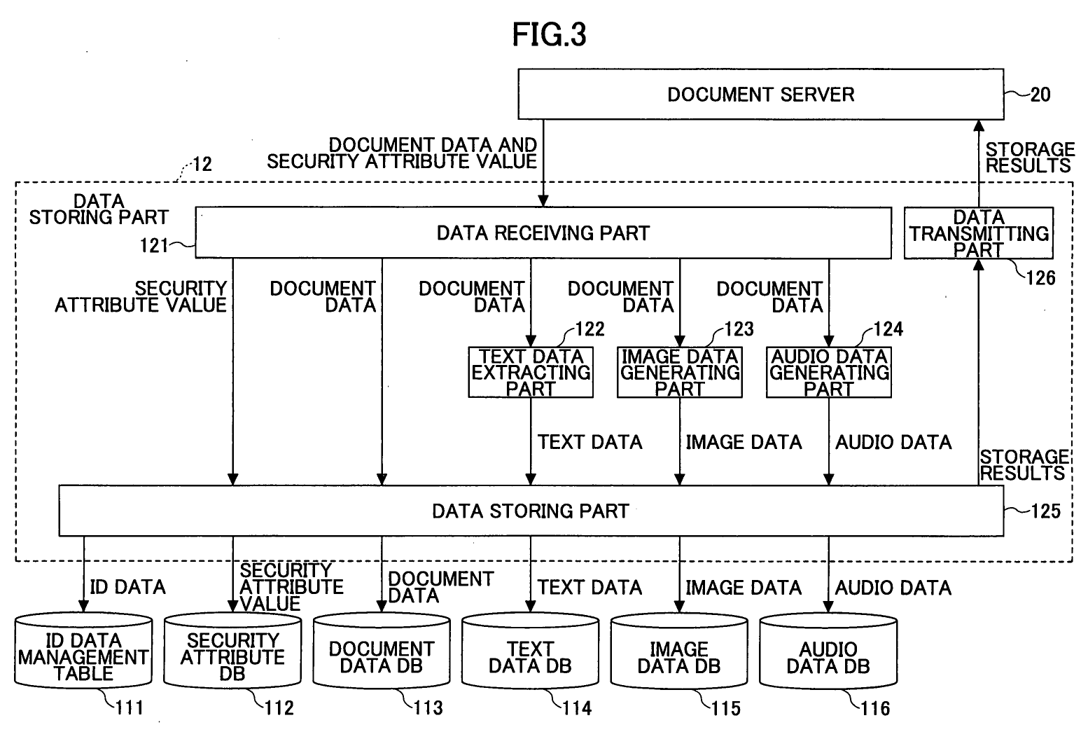

FIG. 3 is a schematic diagram showing an exemplary configuration of the data storing part 12 according to the first embodiment of the present invention. In FIG. 3, the data storing part 12 includes, for example, a data receiving part 121, a text data extracting part 122, an image data generating part 123, an audio data generating part 124, a data storing part 125, and a data transmitting part 126.

The data receiving part 121 receives target documents and its corresponding security attribute values from the document server 20. The text data extracting part 122 generates text data based on the target document. The text information may be generated by using existing software and tools. For example, in a case where the target document uses MS (Microsoft) Word, the text data may be generated by reading the target document with MS Word and selecting a text file as the file type for storing the read out data. In a case where the target document uses MS Power Point, the read out data may be first stored as RTF (Rich Text Format) format and then stored as text data by using MS Word. The text information may also be obtained for PDF documents, Ichitaro documents, etc. by using corresponding software.

In a case where the target document includes image data, text data may be extracted by using OCR (Optical Character Recognition). In a case where the target document includes audio data, text data may be generated by audio recognition.

The image forming part 123 generates image data based on the target document. For example, in a case where the target document uses MS (Microsoft) Word, the text data may be generated by reading the target document with MS Word, writing out the read Word data to a PDF file by using Acrobat Distiller, reading the PDF file with Acrobat, and writing out the read PDF data to a typical image file format (e.g. BMP, TIFF, JPEG).

The audio data generating part 124 generates audio data based on the target document. The audio data may be generated by generating text data based on the target document and executing speech synthesis by using a typical text-to-speech application.

As shown in FIG. 3, the data storing part 125 registers the security attribute values and the target documents received in the data receiving part 121, the text data generated in the text data extracting part 122, the image data generated in the image data generating part 123, and the audio data generated in the audio data generating part 124 in the security attribute DB 112, the document DB, the text data DB 114, the image data DB 115, and the audio data DB 116, respectively. It is to be noted that the data registered in the document DB 113, the text data DB 114, the image data DB 115, and the audio data DB 116 by the data storing part 125 are hereinafter referred to as “registered data”;

The data transmitting part 126 transmits storage results (process results) to the document server 20 in response to data such as the target documents from the document server 20.

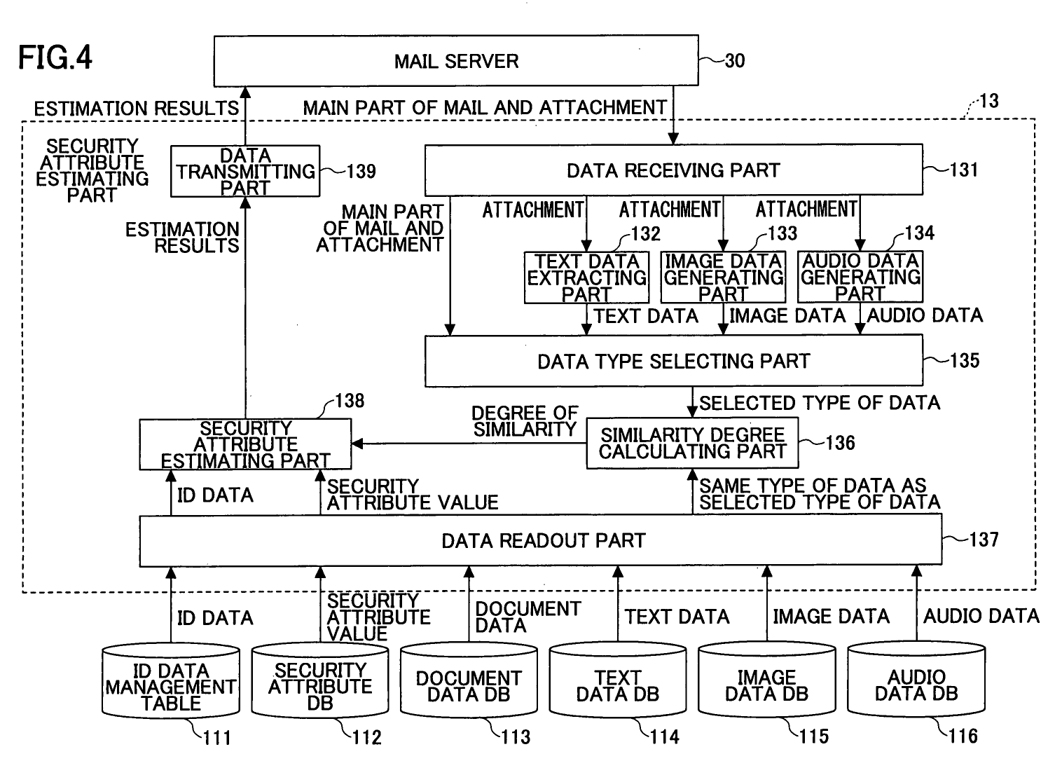

FIG. 4 is a schematic diagram showing an exemplary configuration of the security attribute estimating part 13 according to the first embodiment of the present invention. In FIG. 4, the security attribute estimating part 13 includes, for example, a data receiving part 131, a text data extracting part 132, an image data generating part 133, an audio data generating part 134, a data selecting part 135, a similarity degree calculating part 136, a data readout part 137, a security attribute estimating part 138, and a data transmitting part 139.

The data receiving part 131 receives a main text part of a mail document and its attached document from the mail server 30. The text data extracting part 132, the image data part 133, and the audio data generating part 134 respectively generate text data, image data, and audio data based on the attached document. The methods for generating the text data, the image data, and the audio data may be the same as those used in the text data extracting part 122, the image data generating part 123, and the audio data generating part 124 of the data storing part 12.

The target data selecting part 135 determines which of the text data, the image data, and the audio data (generated based on the main text part of a mail document and its attached document) is suitable for calculating the degree of similarity with respect to the registered data. Then, the target data selecting part 135 selects the data to be used for calculating the degree of similarity based on the determination results. It is to be noted that the data selected by the target data selecting part 135 is hereinafter referred to as “selected data”.

The similarity degree calculating part 136 calculates the degree of similarity between the selected data and respective registered data. The calculation of the degree of similarity is performed on registered data of the same or similar type as the selected data.

The data readout part 137 reads out registered data from the DB group 11 in response to a request from the similarity degree calculating part 136. Furthermore, the data readout part 137 reads out ID data from the ID data management table 111 and/or security attribute value from the security attribute DB in response to a request from the security attribute estimating part 138.

Based on the degree of similarity calculated in the similarity degree calculating part 136, the security attribute estimating part 138 estimates the security attribute value which is to be applied to the main text part of the mail document and its attached document. The data transmitting part 139 transmits the estimation results of the security attribute estimating part 138 (i.e. security attribute value to be applied to the main text part of the mail document and its attached document) to the mail server 30.

Although the data receiving part 121 and the data transmitting part 126 of the data storing part 12 and the data receiving part 131 and the data transmitting part 139 of the security attribute estimating part 13 are illustrated separately in the drawings, the data receiving part 121 and the data receiving part 131 may be provided by sharing the same module and the data transmitting part 126 and the data transmitting part 139 may be provided by sharing the same module. Furthermore, the data communications executed by, for example, the data receiving part 121, the data transmitting part 126, the data receiving part 131, and the data transmitting part 139 of the security attribute estimating part 13 (i.e. communications between the security attribute estimating server 10 and the document server 20 and communications between the security attribute estimating server 10 and the mail server 30) may performed by employing SOAP (Simple Object Access Protocol) that uses HTTP (Hyper Text Transfer Protocol) and XML.

Furthermore, although the text data extracting part 122, the image data generating part 123, and the audio data generating part 124 of the data storing part 12 and the text data extracting part 132, the image data generating part 133, and the audio data generating part 134 of the security attribute estimating part 13 are illustrated separately in the drawings, the text data extracting part 122 and the text data extracting part 132 may be provided by sharing the same module, the image data generating part 123 and the image generating part 133 may be provided by sharing the same module, and the audio data generating part 124 and the audio data generating part 134 may be provided by sharing the same module.

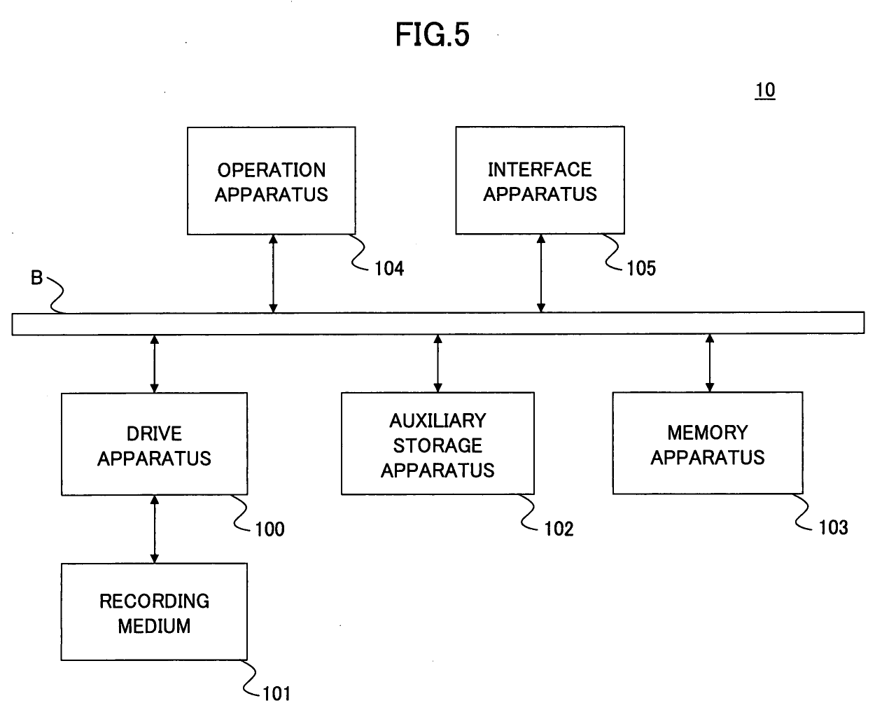

FIG. 5 is a schematic diagram showing an exemplary hardware configuration of the security attribute estimating server 10 according to an embodiment of the present invention. In FIG. 5, the security attribute estimating server 10 includes a drive apparatus 100, an auxiliary storage apparatus 102, a memory apparatus 103, an operation apparatus 104, and an interface apparatus 105 that are connected to each other via a bus B.

The program for executing the process of the security attribute estimating server 10 may be provided by a computer-readable recording medium 101 (e.g. CD-ROM). By setting the computer-readable recording medium 101 (on which the program is recorded) in the drive apparatus 100, the program recorded on the computer-readable recording medium 101 is installed into the auxiliary storage apparatus 102 via the drive apparatus 100.

The auxiliary storage apparatus 102 stores programs loaded thereto as well as other necessary files, data, etc. When starting up of the program is instructed, the memory apparatus 103 reads the program from the auxiliary storage apparatus 102 and stores the program therein. The operation apparatus 104 executes the function (operation) of the security attribute estimating server 10 in accordance with the program stored in the memory apparatus 103. The interface apparatus 105 is used as an interface for connecting to a network (e.g. Internet, LAN).

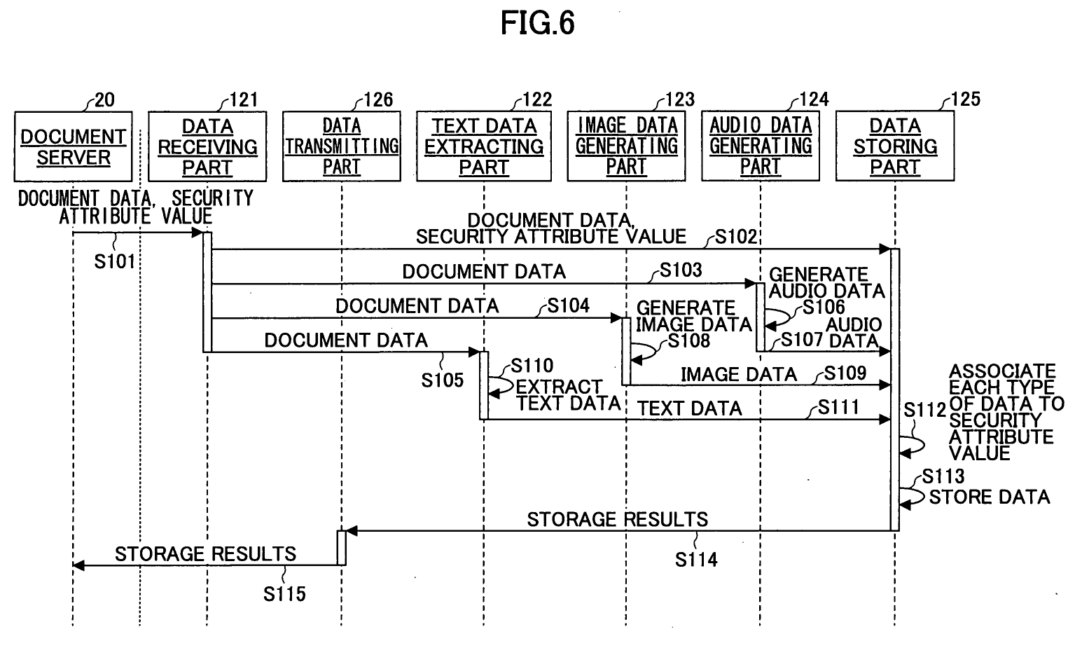

Next, an operation of the security management system 1 according to the first embodiment of the present invention is described. FIG. 6 is a sequence diagram for describing an operation for uploading a target document and its security attribute value from the document server 20 according to the first embodiment of the present invention.

In Step S101, the document server 20 transmits the target document and its security attribute value to the security attribute estimating server 10. The step S101 may be executed at a desired timing, for example, periodically, whenever a target document is uploaded to the document server 20, or whenever the documents stored in the document DB 21 of the document server 20 are updated. Furthermore, the document server 20 is not limited to transmitting a single target document, but may transmit plural target documents along with their corresponding security attribute values to the security attribute estimating server 10.

After receiving the target document and its security attribute value from the document server 20, the data receiving part of the security attribute estimating server 10 transmits the target document and its security attribute value to the data storing part 125 (Step S102). The data receiving part 121 also sends the target document to the audio data generating part 124, the image data generating part 123, and the text data extracting part 122, respectively (Steps S103, S104, S105).

After receiving the target document from the data receiving part 121, the audio data generating part 124, the image data generating part 123, and the text data extracting part 122 each generate secondary data of its corresponding type based on the target document. That is, the audio data generating part 124 generates audio data from the target document (Step S106). The image data generating part 123 generates image data from the target document (Step S108). The text data extracting part generates (extracts) text data from the target document (Step S110). The audio data generating part 124, the image data generating part 123, and the text data extracting part 122 each output their generated data (secondary data) to the data storing part 125 (Steps S107, S109, S111).

It is to be noted that secondary data of multiple types (e.g. audio data, image data, text data) do not have to be generated based on a single target document. For example, any type of data that can be generated (processed) from the original document (target document) may be generated as the second data.

Upon receiving the target document, its corresponding security attribute value, the audio data, the image data, the text data, the data storing part 125 associates the target document and its corresponding security attribute value to the audio data, the image data, and the text data (Step S112). That is, each target document and its corresponding security attribute value are associated with respect to the audio data, the image data, and the text data. For example, this associating process may be executed by using the ID data management table 111.

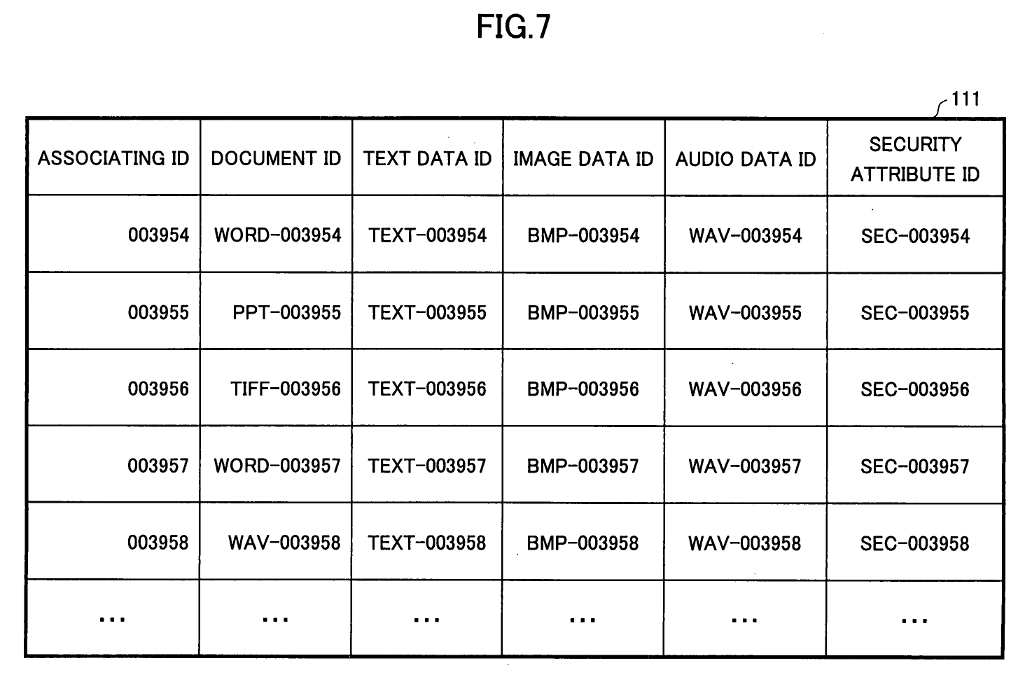

FIG. 7 shows the ID data management table 111 according to an embodiment of the present invention. The items included in the ID data management table 111 are, for example, associating ID, document ID, text data ID, image data ID, audio data ID, and security attribute ID.

The document ID is an ID assigned to each target document by the data storing part 125 so that each document recorded in the document server 113 can be identified. The text data ID is an ID assigned to each text data item by the data storing part 125 so that each text data item recorded in the text data DB 114 can be identified. The image data ID is an ID assigned to each image data item by the data storing part 125 so that each image data item recorded in the image data DB 115 can be identified. The audio data ID is an ID assigned to each audio data item by the data storing part 125 so that each audio data item recorded in the audio data DB 116 can be identified. The security attribute ID is an ID assigned to each security attribute value by the data storing part 125 so that each security attribute value recorded in the security attribute DB 112 can be identified. The associating ID is an ID for identifying each record (including a document ID, a text data ID, an image data ID, an audio data ID, and a security attribute ID) in the ID data management table 111.

More specifically, the data storing part 125 assigns a document ID, a security attribute ID, a text data ID, an image data ID, and an audio data ID to a corresponding document, a corresponding security attribute value, a corresponding text data item, a corresponding image data item, and a corresponding audio data item and generates a record by associating each of the IDs to each target document. Then, each record including the associated IDs is assigned with an associating ID and is recorded in the ID data management table 111. Accordingly, secondary data of each type is associated to each target document.

Then, the data storing part 125 records (stores) the target document, its security attribute value, its text data, its image data, its audio data together with their corresponding IDs in the document DB 113, the security attribute DB 112, the text DB, the image DB 115, and the audio DB 116, respectively (Step S113). The process results of storing (recording) the data and the IDs in the databases are output to the data transmitting part 126 (e.g. whether the storing process is completed normally) (Step S114). The operation is completed after the data transmitting part 126 transmits the storage results to the document server 20.

By generating secondary data of various types based on a target document of the document server 20 and storing the second data of various types in association with security attribute values beforehand in the DB group 11, obtaining data from the document server 20 or generating various secondary data will not be required each time a process of estimating a security attribute value is executed. Accordingly, the speed in executing the security attribute value estimating process can be increased.

Next, a case where the security attribute estimating server 10 executes a process of estimating the security attribute value of a main text part of a mail document and its attached document transmitted from the mail server 30 by using the data and the security attribute values registered in the DB group 11 is described.

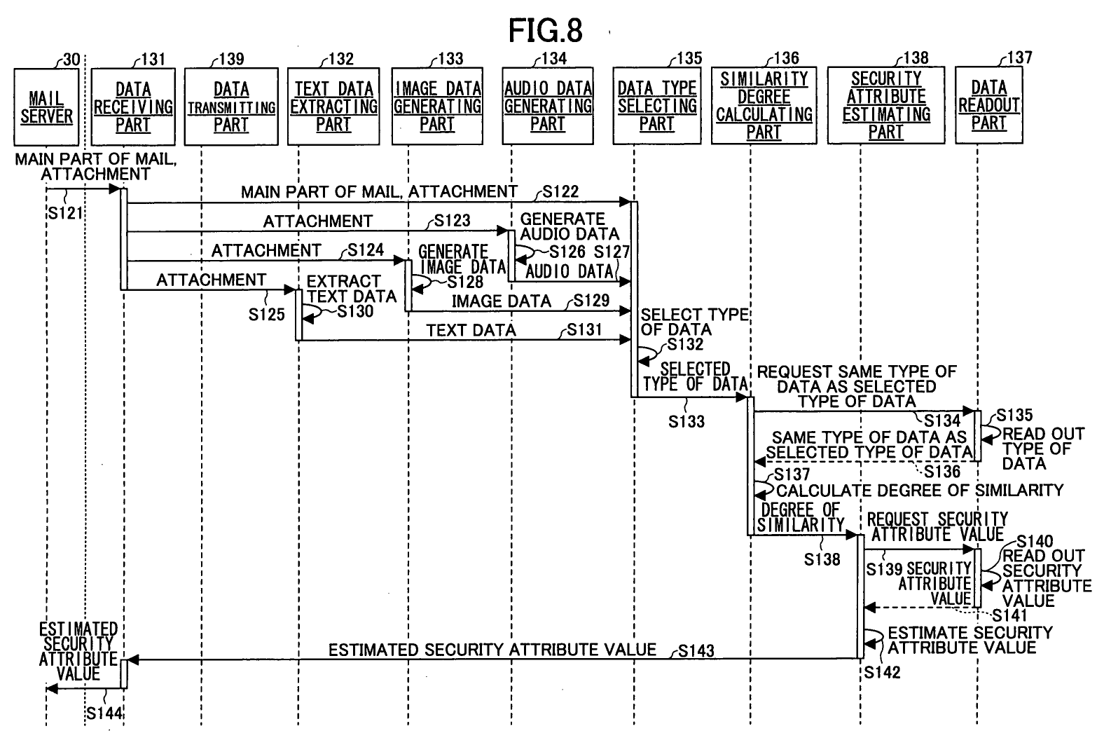

FIG. 8 is a sequence diagram for describing an operation for estimating the security attribute value of the data of a target document according to the first embodiment of the present invention. In this example, the data of the target document is data corresponding to the main text part of a mail document and its attached document transmitted from the mail server 30.

In Step S121, the mail server 30 transmits a main text part of a mail document and its attached document requested by a client 31 to the security attribute estimating server 10. Along with transmitting the main text part and the attached document, the mail server 30 also transmits a request to estimate the security attribute values of the main text part and the attached document to the security attribute estimating server 10.

The data storing part 131 of the security attribute estimating server 10 outputs the received main text part and the attached document to the target data selecting part 135 (Step S122). The data receiving part 131 also outputs the attached document to the audio data generating part 134, the image data generating part 133, and the text data extracting part 132 (Steps S123, S124, S125).

The audio data generating part 134, the image data generating part 133, and the text data extracting part 132 each generates secondary data of a corresponding type based on the same attached document. That is, the audio data generating part 134 generates audio data (Step S126), the image data generating part 133 generates image data (Step S128), and the text data extracting part 132 generates text data (Step S130). Then, the audio data generating part 134, the image data generating part 133, and the text data extracting part 132 each outputs the generated audio data, the image data, the text data to the target data selecting part 135 (Step S127, S129, S131).

It is to be noted that secondary data of multiple types (e.g. audio data, image data, text data) do not have to be generated based on a single target document. For example, any type of data that can be generated (processed) from the original document (target document) may be generated as the second data.

Then, the target data selecting part 135 selects the data (selected data) to be used for calculating the degree of similarity from the text data, image data, and the audio data that are generated by the same main text part and attached document (Step S132).

In determining which data to select, the data may be selected based on an index indicative of, for example, the amount of data or the value of data (hereinafter referred to as “data amount”, so that the degree of similarity can be calculated based on data having more significance. More specifically, the index indicative of the data amount may be data size. This is based on the presumption that a greater amount of significant data is more likely to be included in data having greater data size. In this case, among the main text part of the mail document, the text data, the image data, and the audio data, the data having the greatest number of bytes are selected as the selected data. It is, however, anticipated that the data amount per a predetermined data size is different depending on the type of secondary data. For example, even in a case where the content or significance of the data included in the text data and image data are the same, the image data tends to have a greater size than the text data. In a case of text data and audio data converted from the text data, the audio data tends to have a greater size than the text data.

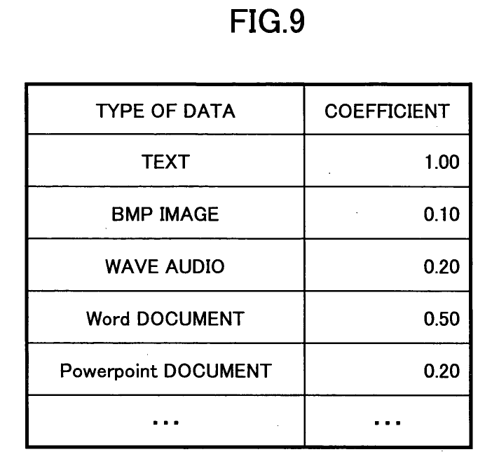

Accordingly, a coefficient may be set beforehand to each type of secondary data, so that the size of each type of secondary data can be normalized by multiplying the size of the secondary data with the coefficient. FIG. 9 is a table showing the coefficients for normalizing the data sizes of each type of secondary data.

The table in FIG. 9 shows the proportion of each type of secondary data in a case where the coefficient for text data is 1.0. For example, according to the coefficient table shown in FIG. 9, image data in a BMP format is multiplied with 0.1, audio data in a WAV (WAVE) format is multiplied with 0.2, and text data is multiplied with 1.0.

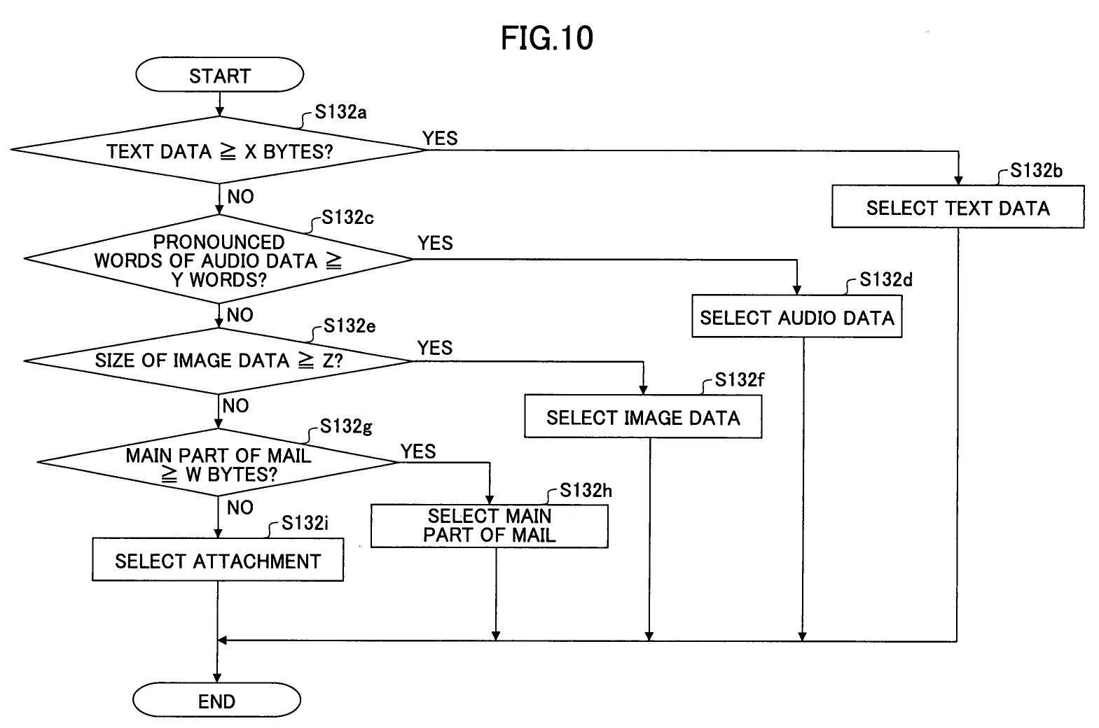

Alternatively, the scale (criterion) to be applied for measuring the data amount of each type of secondary data does not have to the same, but may use different scales (criteria) for indicating the data amount. For example, the number of bytes may be used as the scale (criterion) when measuring the data amount for text data, the number of pronounced words may be used as the scale (criterion) when measuring audio data, and the area of the image may be used as the scale (criterion) when measuring image data. Accordingly, in such case, the various types of secondary data may be selected in accordance with according to a predetermined order of priority. For example, when one of the data items is determined to be greater than a predetermined value upon measuring each type of secondary data according to the priority order, the data item determined to be greater than the predetermined value is selected as the target data. A more detailed example is shown in the flowchart shown in FIG. 10. In the example shown in FIG. 10, the priority order for selecting the target data is: text data generated from the attached document; audio data generated from the attached document; image data generated from the attached document; and the main text part of the mail document. FIG. 10 is a flowchart for describing an operation of selecting target data. First, it is determined whether the number of bytes of the text data is greater than a predetermined amount (Step S132a). In a case where the number of bytes is greater than the predetermined amount (X bytes) (Yes in Step S132a), the text data is selected as the target data (Step S132b). In a case where the number of bytes is less than the predetermined amount (No in Step S132a), it is determined whether the audio data is greater than a predetermined amount (Y words) (Step S132c). In a case where the audio data is greater than the predetermined amount (Yes in Step S132c), the audio data is selected as the target data (Step S132d). In a case where the audio data is less than the predetermined amount (No in Step S132c), it is determined whether the area (size) of the image data is greater than a predetermined amount (Z) (Step S132e). In a case where the image data is greater than the predetermined amount (Yes in Step S132e), the image data is selected as the target data (Step S132f). In a case where the image data is less than the predetermined amount (No in Step S132e), it is determined whether the number of bytes of the main text part of the mail document is greater than a predetermined amount (W bytes) (Step S132g). In a case where the number of bytes of the main text part of the mail document is greater than the predetermined amount (Yes in Step S132g), the main text part is selected as the target data (Step S132h). In a case where the number of bytes of the main text part of the mail document is less than the predetermined amount (No in Step S132g), the attached document in an unprocessed state is selected as the target data (Step S132i).

Furthermore, as another index for indicating the data amount (data content) of the generated data, an index indicative of the probability of containing data having meaning (hereinafter referred to as “data content proportion”) may be used.

The proportion of the data content of text data may be, for example:

1) the proportion between the size of the original data (in this example, the original attached document) (Do) and the size of the generated text data (Dt)→Dt/Do;

2) the reversible compression of the generated text data from the aspect of redundancy of data→Ct;

3) the proportion between the size of the original data (Do) and the number of letters of the generated text data (T)→T/Do; and

4) the proportion between the size of the original data (Do) and the number of words of the generated text data (W)→W/Do.

Any one of the data content proportions 1)-4) may be selected for use beforehand or may be selected according to the original data or according to the software used for data conversion. Alternatively, all of the data content proportions 1)-4) may be calculated and selected according to the results of the calculation.

The proportion of the data content of image data may be, for example:

1) the proportion between the size of the original data (Do) and the size of the image data (Di)→Di/Do;

2) the reversible compression of the image data→Ci;

3) the entropy of the image data H; and

4) the proportion of black pixels and white pixels in the image data→Kth/N, Wth/N;

wherein the size of the original data is indicated as “Do” (bytes), the entropy of the generated image data is indicated as “H”, the number of pixels being blacker than threshold th is indicated as “Kth” (dots), the number of pixels being whiter than threshold th is indicated as “Wth” (dots), the reversible compression according to a lzw algorithm.

Any one of the data content proportions 1)-4) may be selected for use beforehand or may be selected according to the original data or according to the software used for data conversion. Alternatively, all of the data content proportions 1)-4) may be calculated and selected according to the results of the calculation.

In a case where the total number of pixels is “N” and the number of pixels of level i is “Ni”, the relationship of the entropy (H) of the above-described image data in content proportion 3) and the percentage Pi of deriving a pixel of level i is expressed with the below formula.
H=−ΣPᵢlog₂Pᵢ, Pᵢ=Nᵢ/N

Furthermore, in a case of audio data, data content proportion may be calculated in relation to a time base so that a desired type of data may be selected in correspondence to various time periods. For example, in a case of music data, the degree of similarity is determined whether text data of a singing part of a song is similar to the data in the lyric DB. However, in a part without singing (e.g. intro, bridge), the degree of similarity is determined based on audio data. In other words, although the calculating of data content proportion, the calculating of similarity degree, and the estimating of security attributes for electronic files or image files are executed in units of pages or images, the security attributes for audio data can be effectively estimated by dividing the audio data with respect to the time base direction. Accordingly, the time period of the song part can be recognized by the data content proportion of the text data obtained by audio recognition, and the time period of a soundless part (part having no meaning) can be recognized by the data content proportion of the audio data. Thus, the type of data for calculating the degree of similarity can be selected according to the divided time periods.

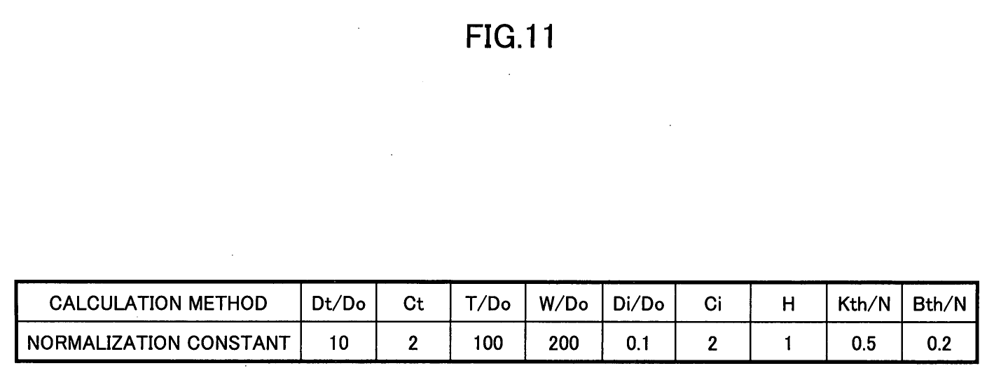

The data to be selected as the target data may be, for example, the secondary data having the greatest data content proportion according to the calculation of the above-described methods. However, it cannot be determined which of the data content proportion for text data, image data, and audio data cannot is larger than the other owing that the index and scale of each data content proportion are different. Therefore, a coefficient can be set for each of the data content proportions. By multiplying the coefficients with each data content proportion, the data content proportions can be normalized. FIG. 11 is an exemplary coefficient table for normalizing each data content proportion.

It is preferable to set the coefficients in the table of FIG. 11 in accordance with, for example, the type of the original data, the type of data to be converted, the method used for data conversion, or the tool used for data conversion. For example, the original document may be a MS Word file, the extraction (generation) of the text data may be executed with use of xdoc2txt, and the generation of image data may be executed by forming PDF data from a Word file with Press Quality and converting the PDF data into JPEG format by using Acrobat.

Next, the operation of FIG. 8 is further described. After selecting the target data in Step S132, the target data selecting part 135 outputs the selected data to the similarity degree calculating part 136. Then, the similarity degree calculating part 136 requests the data readout part 137 to readout the same type of registered data as that of the selected target data (Step S134). Then, in response to the request by the similarity degree calculating part 137, the data readout part 137 reads out a part or all of the registered data in the database (DB) corresponding to the type of the selected target data (Step S135), and outputs the readout registered data to the similarity degree calculating part 136 (Step S136). For example, in a case where the type of data requested by the similarity degree calculating part 136 is text data, the data readout part 137 reads out a part of or all of the text data registered in the text data DB 114. The registered data read out by the data readout part 137 is hereinafter referred to as “comparison target data”.

Then, the similarity degree calculating part 136 calculates the degree of similarity between the selected target data and corresponding comparison target data (Step S137), and outputs the calculation results for each comparison target data item to the security attribute estimating part 138 (Step S138). Based on the degree of similarity for each comparison, the security attribute estimating part 138 identifies the data to be referred for estimating the security attribute value (hereinafter referred to as “reference comparison target data”) from the comparison target data according to the similarity degree for each comparison target data item and requests the data readout part 137 to read out the security attribute value of the reference comparison target data (Step S139). It is to be noted that one or more reference comparison target data may be read out and referred for estimating security attribute value.

The data readout part 137 reads out a security attribute value associated to the reference comparison target data from the security attribute DB 112 (Step S140) and outputs the readout security attribute value to the security attribute estimating part 138 (Step S141). The security attribute estimating part 138 employs a predetermined method (hereinafter referred to as “estimating method”) and estimates the security attribute value to be applied to the selected data type of the main mail part and the attached document by referring to the read out security attribute value (Step S142). Then, the security attribute estimating part 138 outputs the result of the estimation to the data transmitting part 139 (Step S143). Then, the data transmitting part 139 transmits the estimation result including the estimated security attribute value to the mail server (Step S144). Thereby, the operation is completed.

The mail server 30, receiving the estimation result, can use the estimated security attribute value for executing various processes such as obtaining access data of a document containing the estimated security attribute value, determining access authority, or reporting the estimation result to a document managing administrator and controlling mail transmission according to the response from the document managing administrator. More specifically, for example, deleting mail, transmitting a copy of mail to the document managing administrator, associating mail to a log and storing the log, alerting the document managing administrator, or alerting the sender of mail in accordance with the estimated security attribute value. These processes may be executed separately or in combinations.

In FIG. 8, the step of calculating the degree of similarity between the target selected data item and each comparison target data item with the similarity degree calculating part 136 (Step S137) may be executed by using various methods such as the methods described below.

First, an exemplary method of calculating the degree of similarity between one text data item and another text data item is described.

A selected target data item is divided into plural blocks (hereinafter referred to as “key-block”). It is determined whether a comparison target data item is included in the key-blocks. The determination may be executed by any one of the examples 1)-4) described below.

1) A single selected data item is entirely used as a single key-block. Accordingly, the character strings comprised in a single key-block is subject to the determination. That is, it is determined whether the entire text of the key-block is included in the comparison target data item.

2) An indention code is used to delimit the key-blocks of the selected target data item. Accordingly, it is determined whether the character strings comprised in a single key-block (delimited by the indention code) is included in the comparison target data item.

3) Punctuations used in a regular sentence (e.g. comma, period, or a quotation mark) are used to delimit the key-blocks of the selected target data item. Accordingly, it is determined whether the character strings comprised in a single key-block (delimited by the punctuation) is included in the comparison target data item.

4) A tab or a space is used to delimit the key-blocks of the selected target data item. Accordingly, it is determined whether the character strings comprised in a single key-block (delimited by the tab, space) is included in the comparison target data item.

One or more of the above-described examples 1)-4) may be used separately or in combinations. Other than the simple delimiting used in the above-described examples, morphological analysis may be used for, for example, identifying nouns and delimiting the selected data item with nouns.

By executing the determination with respect to each key-block, the degree of similarity can be obtained with the below-described formula.

$$Si = \frac{{\sum }_{j = 1}^{BF} \{ WBj \times BAij \}}{WAi} \qquad ( i = 1 , … , N )$$

The variables of the above-described formula are described below.

Sᵢ: the degree of similarity with respect to the i^{th} comparison target;

BF: the number of key-blocks extracted from a selected target data item;

WBj: the number of characters in the j^{th} key-block;

BAᵢⱼ: the number of j^{th} key-blocks included in the i^{th} comparison target data item;

WAᵢ: the number of characters in the i^{th} comparison target data item; and

N: the number of comparison target data items stored in the DB group 11.

In a case where the above-described example 1) is used, the degree of similarity is “1” when the entire text of a document of a comparison target data item is written (included) in the main text part of the mail document or when the entire text of a document of a comparison target data item is written (included) in the attachment document.

Next, an exemplary method of calculating the degree of similarity between one image data item and another image data item is described. In calculating the degree of similarity of image data, a product that compares features in a real space (e.g. VIS Meister, http://www.ricoh.co.jp/vismeister/) may be used. Alternatively, each image data item may be transformed into a frequency element by using orthogonal transformation (e.g. discrete Fourier transform, Discrete Cosine Transform), and 1 may be subtracted from the mean-square-error (0−1) of each image data item, to thereby calculate the degree of similarity for image data.

Next, an exemplary method of calculating the degree of similarity between one audio data item and another audio data item is described. In the similar manner as calculating the degree of similarity for image data, the degree of similarity for audio data may be calculated by having each audio data item transformed into a frequency element by using orthogonal transformation (e.g. discrete Fourier transform, Discrete Cosine Transform) and subtracting 1 from the mean-square-error (0−1) of each audio data item.

Next, an exemplary method of calculating the degree of similarity between one document data item (document file) and another document data item (document file) is described. In a similar manner as the method of calculating the degree of similarity for text data, the document data item is delimited to, for example, “100 Bytes” rather than delimiting with respect to the text. It is determined whether binary data of 100 bytes in a selected document data item is included in a comparison document data item stored in a file. After determining whether the document data item is included, the total sum of the calculation is obtained, thereby calculate the degree of similarity for document data.

In FIG. 8, the step of estimating the security attribute with the security attribute estimating part 138 (Step S142) may be executed by any one of the examples 1)-4) described below.

1) The security attribute value of the comparison target data item having the highest degree of similarity is estimated to be the security attribute value of the selected target data item.

2) The security attribute values for a number of comparison target data items having high degree of similarity are obtained, and the comparison target data items having the maximum security attribute value is estimated to be the security attribute value of the selected target data item.

3) The average of the security attribute values for a number of comparison target data items having high degree of similarity is obtained, and the obtained average of security attribute value is estimated to be the security attribute value of the selected target data item.

4) A list of security attribute values for a number of comparison target data items having high degree of similarity is obtained, and the obtained list is estimated to be the security attribute value of the selected target data item. In other words, plural choices of security attribute values are sent, for example, to the mail server 30 and entrusted to the discretion of the mail server 30 in a subsequent step.

One or more of the above-described examples 1)-4) may be used separately or in combinations. The examples may be selected according to the kind of security attribute. For example, in a case where the secrecy level is linearly defined as Level 1, Level 2, and Level 3, it is preferable to use the example 2) and 3) for estimating the security attribute value. Furthermore, in a case where the security attribute is related to a secrecy maintaining date, a secrecy expiration date, or a secret preserving date, it is preferable to use the example 2). In a case where the security attribute is related to, for example, company rank, authorized personnel, authorized group, it is preferable to use the example 1) or 4).

With the above-described security managing system 1, in a case of transmitting a main text part of a mail document or its attached document that is not set with security data (undefined data) such as access authorization, security data corresponding to registered data that are identical or similar to the undefined data are applied to the undefined data. Accordingly, not only in a case of transmitting data registered in a database (defined data) by including the data in a main text part of a mail document or as an attachment of the mail document, but also in a case of transmitting undefined data that is similar to the data registered in a database by including the data in a main text part of a mail document or as an attachment of the mail document, the transmission of the undefined data can be efficiently controlled based on the security data of the corresponding identical or similar registered data.

Furthermore, since the data used for calculating similarity between a main text part of a mail document or an attachment attached to the mail document and a registered data item is selected by generating various types of processed data from the mail document or the attachment and determining which of the types of processed data have meaning (significance), a more reliable result can be expected in calculating the degree of similarity. Thus, a suitable security value can be estimated for the main text part of the mail document or the attachment attached to the mail document.

Next, a security attribute estimating part according to a second embodiment of the present invention is described. The configuration of the security management system 1 (FIG. 1), the function parts of the security management server 10 (FIG. 2), and the configuration of the data storing part 12 (FIG. 3) of the second embodiment of the present invention are basically the same as those of the first embodiment of the present invention.

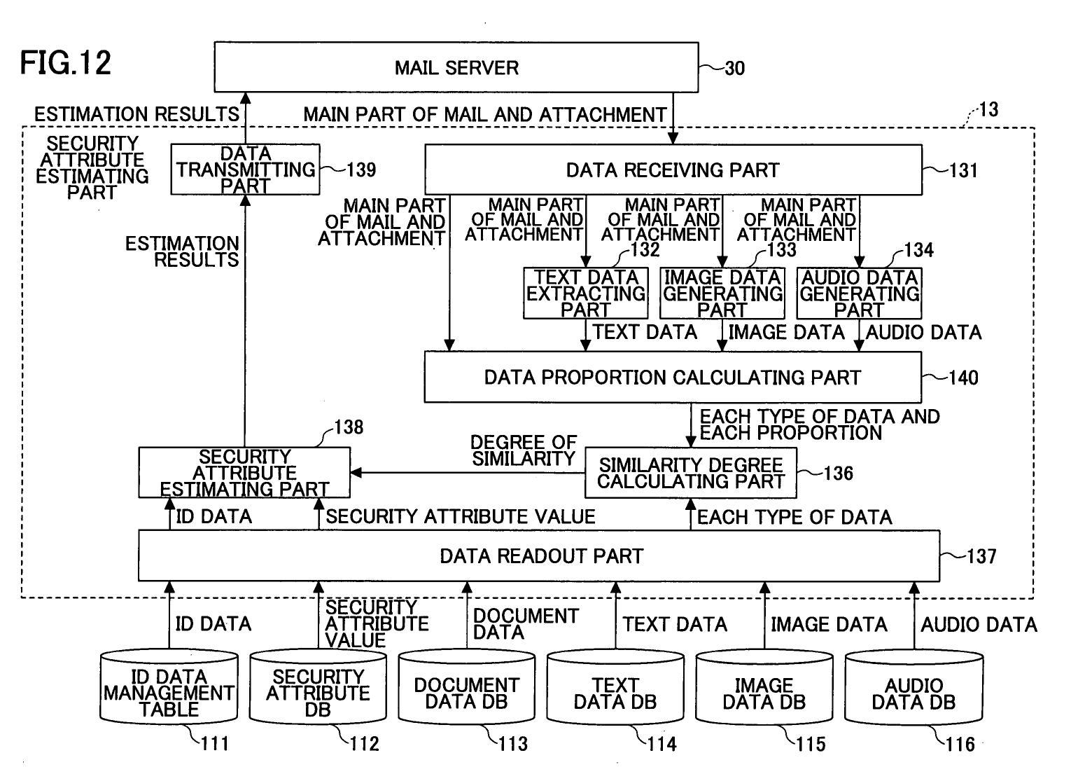

FIG. 12 is a schematic diagram showing a configuration of a security attribute estimating part according to the second embodiment of the present invention. In FIG. 12, like components are denoted with like reference numerals as of FIG. 4 and are not further explained.

In FIG. 12, a data proportion calculating part 140 is provided instead of the data type selecting part 135 of the first embodiment. The data proportion calculating part 140 calculates the proportion of the data size of each type of processed data (e.g. text data, image data, audio data) generated from a main text part of a mail document or an attachment attached to the mail document.

The similarity degree calculating part 136 of the second embodiment calculates the degree of similarity according to the proportion calculated by the data proportion calculating part 140.

Next, an operation of the security management system 1 according to the second embodiment of the present invention is described. Since the operation of uploading document data and its security attribute values from the document server 20 is the same as the first embodiment of the present invention (FIG. 6), further explanation thereof is omitted.

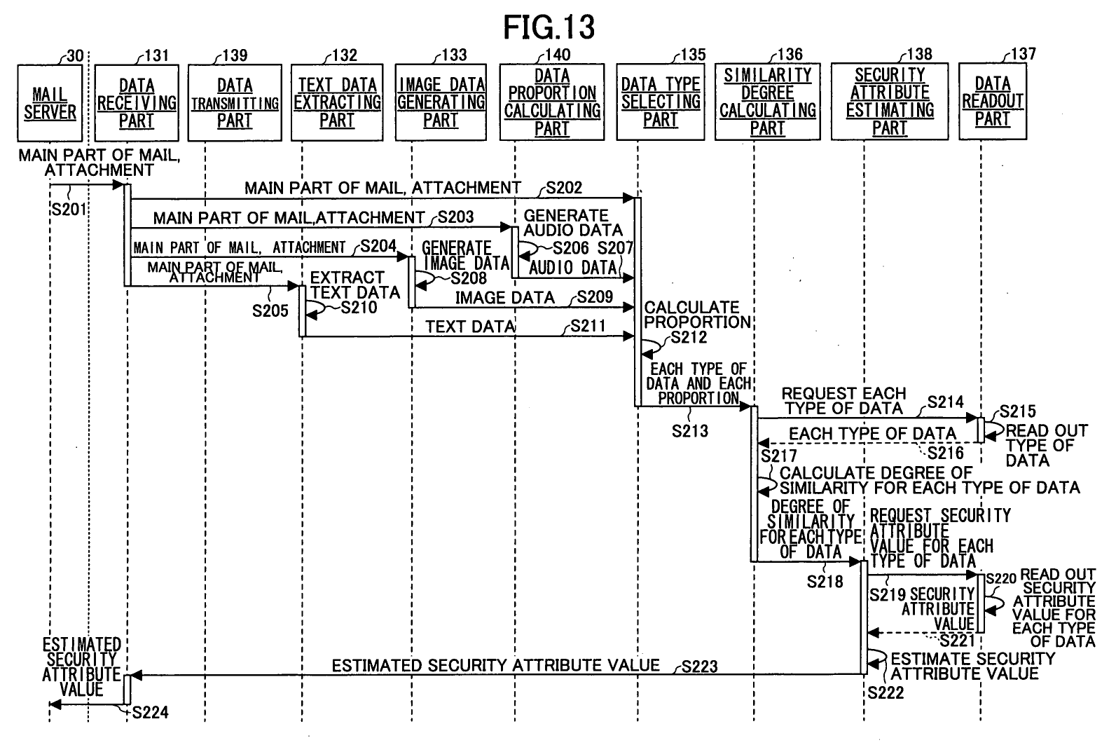

FIG. 13 is a sequence diagram for describing an operation of estimating the security attribute value of a target data item (undefined data item) according to the second embodiment of the present invention.

In FIG. 13, Steps S201-S211 are the same as Steps S121-S131 of the first embodiment except for the fact that the main text part of the mail document, the attachment attached to the mail document, the generated audio data, image data, and text data are output to the data proportion calculating part 140.

Then, in Step S212, the data proportion calculating part 140 calculates the data size of each type of data (i.e. the main text part of the mail document, the attachment attached to the mail document, audio data, image data, text data) for comparison with each type of data received from, for example, the document database 113. Although the proportion of data size may be compared based on the number of bytes of each type of data (i.e. the main text part of the mail document, the attachment attached to the mail document, audio data, image data, text data) as they are, it is preferable to compare normalized values by multiplying the number of bytes with a predetermined coefficient as described in FIG. 9.

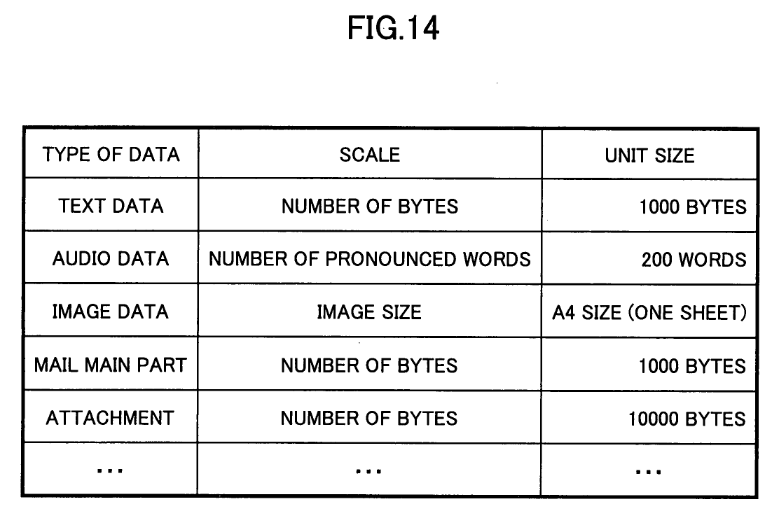

In one example, the unit size of each type of data may be set beforehand as shown in the table of FIG. 14 (described below). Accordingly, the proportion of data size can be calculated based on the unit sizes listed in the table.

FIG. 14 shows a table indicating of unit sizes corresponding to various types of data. As shown in FIG. 14, the scale for text data is the number of bytes, the scale for audio data is the pronounced number of words, the scale for image data is image area, the scale for the main text part of a mail document is the number of bytes, and the scale for an attachment attached to the mail document is the number of bytes, in which the unit sizes thereof are 1000 bytes, 200 words, A4, 1000 bytes, and 10000 bytes, respectively. Accordingly, the proportions of the data sizes of each type of processed data are calculated by dividing the number of bytes of text data with 1000 bytes, dividing the number of words of the audio data with 200 words, dividing the area of the image data with an area of A4, dividing the number of bytes of the main text part of the mail document with 1000 bytes, and dividing the number of bytes of the attachment of the mail document with 10000 bytes, respectively.

Alternatively, instead of calculating the proportion of data size, the proportion of the amount of data (as in the first embodiment) for each type of data may be calculated.

Then, in Step S213, the data proportion calculating part 140 outputs each type of processed data, the proportion of data size or the proportion of data amount of the processed data to the similarity degree calculating part 136.

Then, in Step S214, the similarity degree calculating part 136 requests the data readout part 137 to read out respective types of data registered in the database group 11. Then, in response to the request, the data readout part 137 reads out one or more types of data (comparison data) stored in the database group 11 (Step S215) and outputs the read out data to the similarity degree calculating part 136 (Step S216).

Then, the similarity degree calculating part 136 calculates the degree of similarity between each type of the processed data (i.e., the main text part of the mail document, the attachment attached to the mail document, audio data, image data, text data) and one or more of the read out comparison data (Step S217). Then, the similarity degree calculating part 136 outputs the calculated degree of similarity for each type of processed data to the security attribute estimating part 138 (Step S218).

In this example, each degree of similarity may be multiplied with the proportion of the types of data or the proportion of the amount of data, so that each type of data can be weighted with respect to the proportion of the data type or the data amount. The method of calculating the degree of similarity may be the same as that described in the first embodiment of the present invention.

Next, the security attribute estimating part 138 identifies a reference data item from the comparison data based on the calculated degree of similarity and requests the data readout part 137 to read out the security attribute value of the identified reference data item (Step S219). The security attribute reference data item is to be used as reference for estimating the security attribute value of a selected data item.

In this example, the data item having the highest degree of similarity among the calculated degree of similarity of all types of data (degree of similarity for the data of the main part of a mail document, the data of an attachment of the mail document including text data, image data, and audio data, respectively) is selected (identified) as the reference data item.

In another example, the total value of the calculated degrees of similarity for each type of data included in an attachment attached to a mail document may be obtained so that the reference data item may be selected by comparing with the obtained total value. In this case, the attachment having the maximum total value is selected as the reference data item.

Then, the similarity degree calculating part 136 requests the data readout part 137 to read out the security attribute value associated to the reference data item (Step S219). Then, in response to the request, the data readout part 137 reads out the security attribute value associated to the reference data item from the security attribute DB (Step S220) and outputs the read out security attribute value to the security attribute estimating part 138 (Step S221).

Then, the security attribute estimating part 138 estimates the security attribute value to be applied to the mail document and its attachment in accordance with the read out security attribute value (Step S222). The method of estimating the security attribute value may be the same as that described in the first embodiment of the present invention. Since the steps after Step S222 are the same as those of the first embodiment of the present invention, further description thereof is omitted.

In the security attribute estimating server 10 according to the second embodiment of the present invention, the security attribute value is estimated by calculating the degree of similarity for all of the types of registered data and weighting the calculated degrees of similarity according to the proportion of data or the proportion of the amount of data. Accordingly, the security attribute value can be estimated according to more reliable processed data. Thereby, a more suitable result can be expected.

Next, a security management system 3 according to a third embodiment of the present invention is described. In this embodiment, the security attribute value of image data obtained from a scanner, a copier, or a multi-function apparatus is estimated.

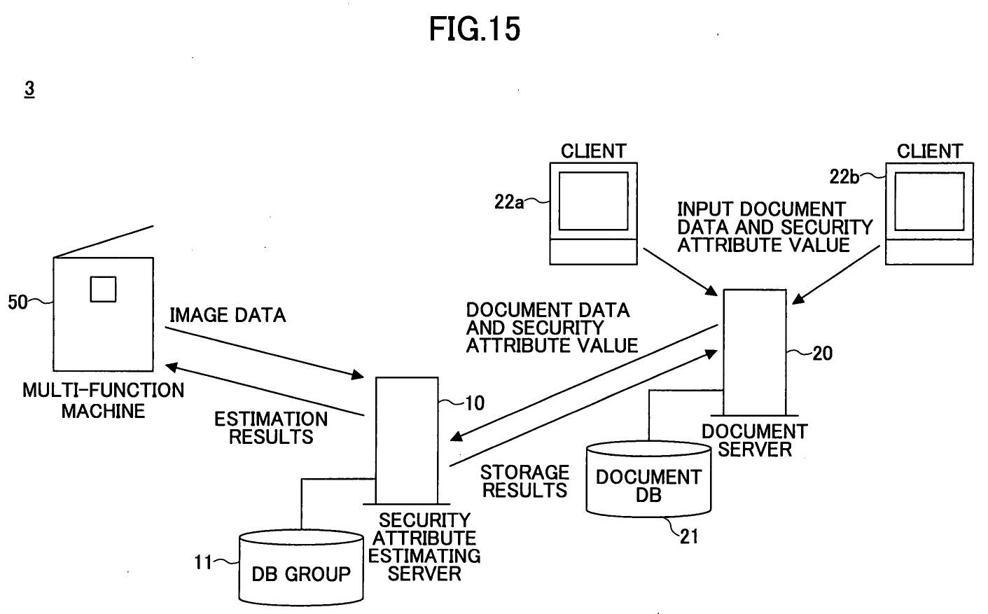

FIG. 15 shows an exemplary configuration of the security management system 3 according to the third embodiment of the present invention. In FIG. 15, like components are denoted with like reference numerals as of FIG. 1 and further explanation thereof is omitted. In comparing FIG. 15 and FIG. 1, the security management system 3 includes a multi-function apparatus 50 instead of a mail server 30. The multi-function apparatus 50 includes, for example, the function of a printer, a facsimile, a copier, and/or a scanner. It is, however, to be noted that an apparatus having one of said functions may alternatively used as the multi-function apparatus 50.

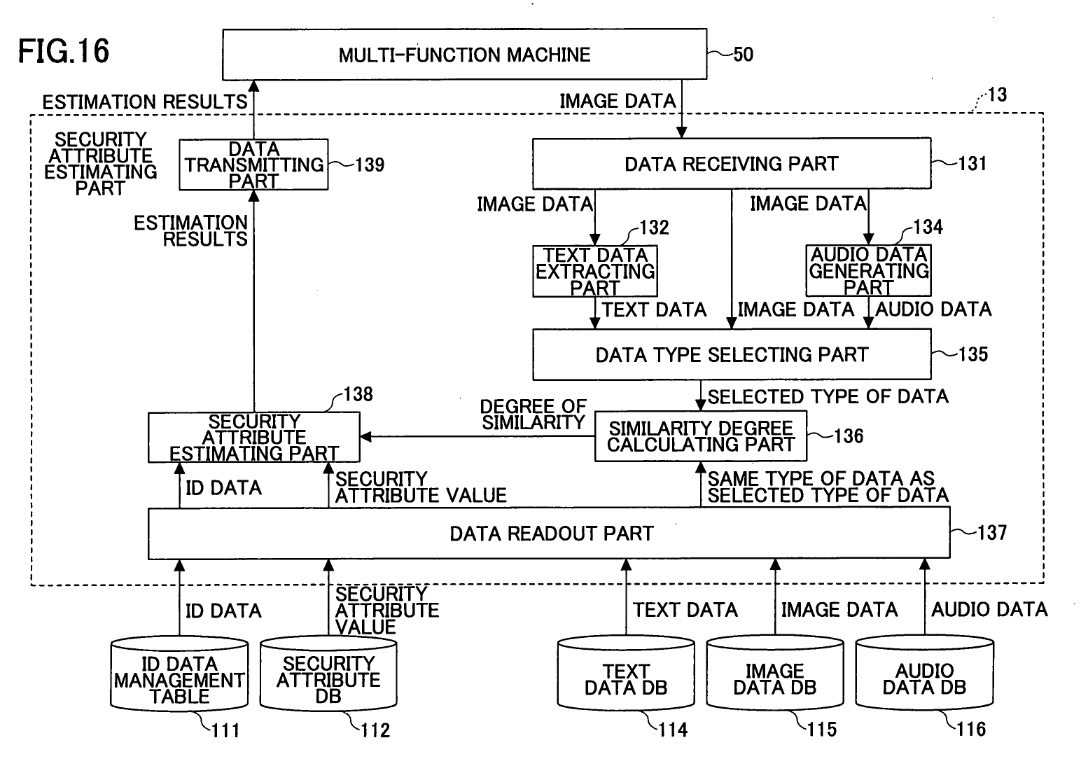

FIG. 16 is a schematic diagram showing an exemplary configuration of a security attribute estimating part 13 according to the third embodiment of the present invention. In FIG. 16, like components are denoted with like reference numerals as of FIG. 4 and are not described in further detail.

In FIG. 16, instead of receiving a main part of a mail document and its attachment as in the first embodiment (See FIG. 4), the data receiving part 131 of the third embodiment receives image data from the multi-function apparatus 50. Therefore, unlike the first embodiment, the security attribute estimating part 13 according to the third embodiment does not have an image data generating part 133. It is to be noted that the data storing part 12 of the third embodiment has the same configuration as that of the first embodiment.

Next, an operation of the security management system 3 according to the third embodiment of the present invention is described. Since the operation of uploading document data and its security attribute values from the document server 20 is the same as the first embodiment of the present invention (FIG. 6), further explanation thereof is omitted.

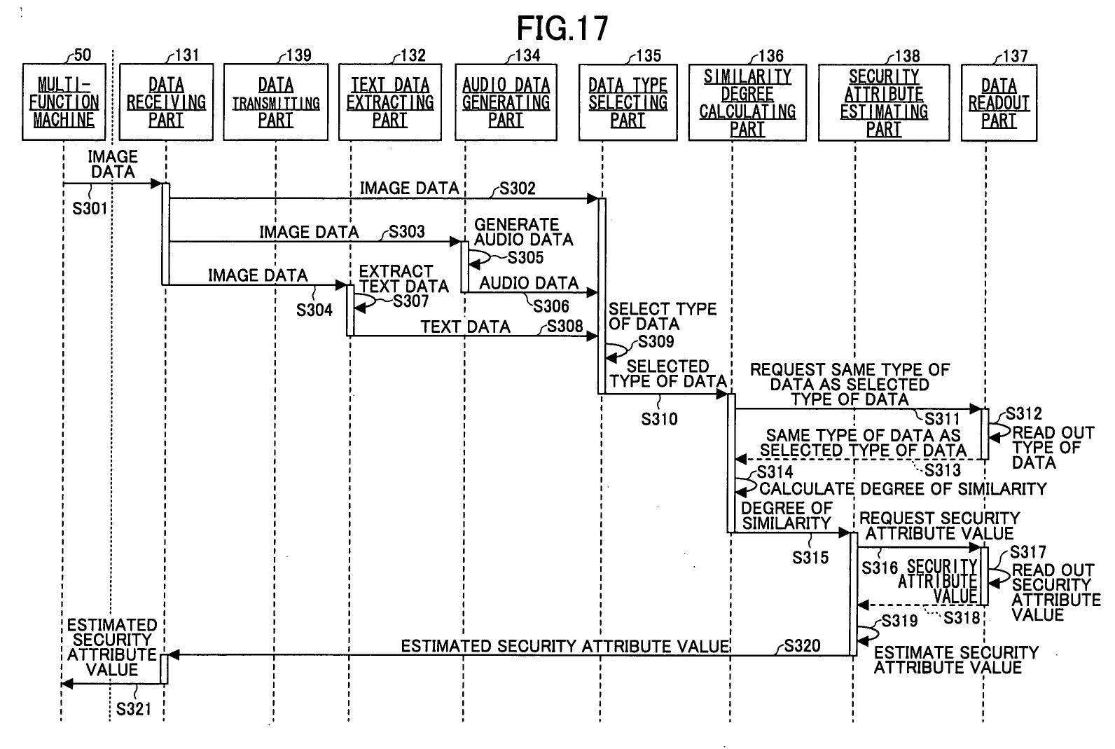

FIG. 17 is a sequence diagram for describing an operation of estimating the security attribute value of a target data item (undefined data item) according to the third embodiment of the present invention. In the third embodiment, the target data item (undefined data item) for estimating the security value is an image data item transmitted from the multi-function apparatus 50.

First, the multi-function apparatus 50 transmits a scanned image data item and a request for estimating the security attribute value of the image data item to the security attribute estimating server 10 (Step S301). The image data item or image data may be transmitted at a given timing, for example, whenever a document is scanned by executing a scanning function or a copying function of the multi-function apparatus 50, when image data of some amount is stored, or in predetermined periods (periodically).

Then, the data receiving part 131 in the security attribute estimating server 10 outputs the received image data item to the data type selecting part 135, the audio data generating part 134, and the text data extracting part 132, respectively (Steps S302, S303, S304).

The audio data generating part 134 and the text data extracting part 132 each generate a corresponding type of data from the received image data. That is, the audio data generating part 134 generates audio data from the image data item (Step S305) and outputs the audio data to the data type selecting part (Step S306). The text data extracting part 132 generates text data from the image data item (Step S307) and outputs the text data to the data type selecting part (Step S308).

It is, however, to be noted that plural types of data (e.g. audio data, text data) does not have to be generated (processed) from the image data item, but a single type of data may also be generated from the image data item. In other words, the type of data to be generated (processed) in the security attribute estimating part 13 may be generated (processed) depending on the property of the image data item (undefined data item).

Since the steps after Step S308 (i.e. S309-S321) are the same as those of Steps S132-S144 of FIG. 8, further description thereof is omitted.

In the security management system 3 according to the third embodiment of the present invention, an undefined image data item being scanned by the multi-function apparatus 50 can be applied with a security attribute value of a registered data item including an identical or similar type of data as the undefined data item. Accordingly, in a case where a document containing data registered in a database is scanned or copied by the multi-function apparatus 50, the security attribute value associated to the document is applied to the scanned data or copied data. Furthermore, in a case where a document containing data similar to the data registered in a database is scanned or copied by the multi-function apparatus 50, the security attribute value associated to the document is applied to the scanned data or copied data. Accordingly, the security for such scanned data or copied data can be managed efficiently.

Next, an operation of the security management system 4 according to the fourth embodiment of the present invention is described. In this embodiment, the security attribute value of audio data obtained from a telephone (audio telephone) is estimated.

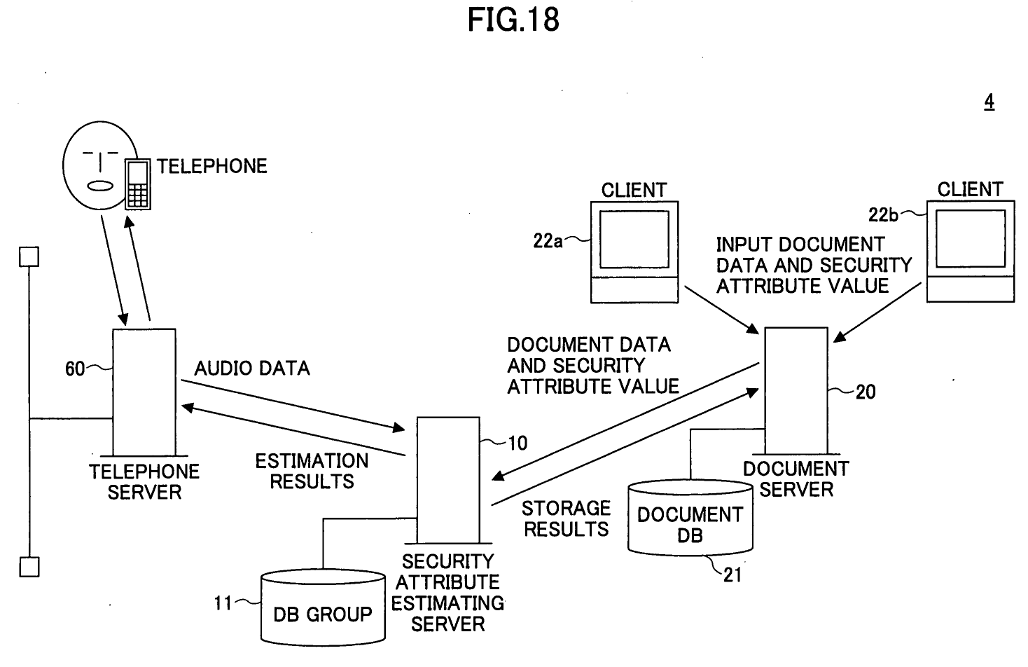

FIG. 18 shows an exemplary configuration of the security management system 4 according to the fourth embodiment of the present invention. In FIG. 18, like components are denoted with like reference numerals as of FIG. 1 and further explanation thereof is omitted. In comparing FIG. 18 and FIG. 1, the security management system 4 includes an audio server (e.g. telephone server) 60 instead of a mail server 30. The audio server 60 includes, for example, an IP telephone server or a telephone exchange. The audio server 60 transmits audio data (e.g. telephone conversions on the telephone) to the security attribute estimating server 10.

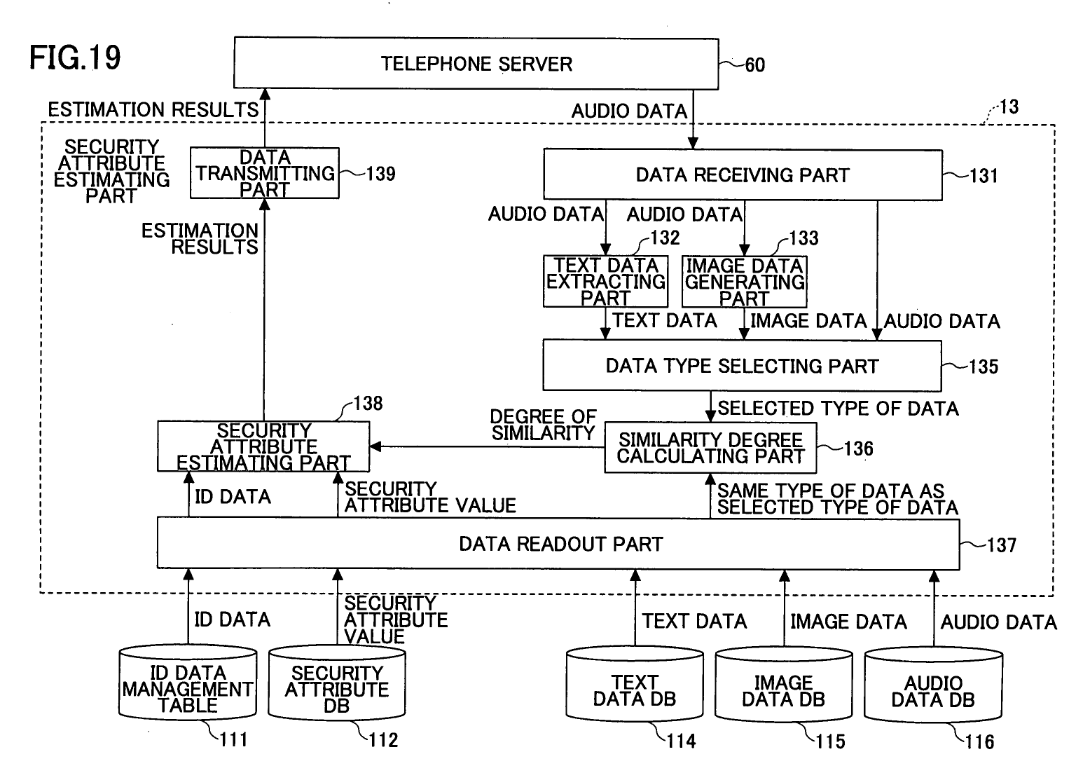

FIG. 19 is a schematic diagram showing an exemplary configuration of a security attribute estimating part 13 according to the fourth embodiment of the present invention. In FIG. 19, like components are denoted with like reference numerals as of FIG. 4 and are not described in further detail.

In FIG. 19, instead of receiving a main part of a mail document and its attachment as in the first embodiment (See FIG. 4), the data receiving part 131 of the fourth embodiment receives audio data from the audio server 60. Therefore, unlike the first embodiment, the security attribute estimating part 13 according to the fourth embodiment does not have an audio data generating part 134. It is to be noted that the data storing part 12 of the fourth embodiment has the same configuration as that of the first embodiment.

Next, an operation of the security management system 4 according to the fourth embodiment of the present invention is described. Since the operation of uploading document data and its security attribute values from the document server 20 is the same as the first embodiment of the present invention (FIG. 6), further explanation thereof is omitted.

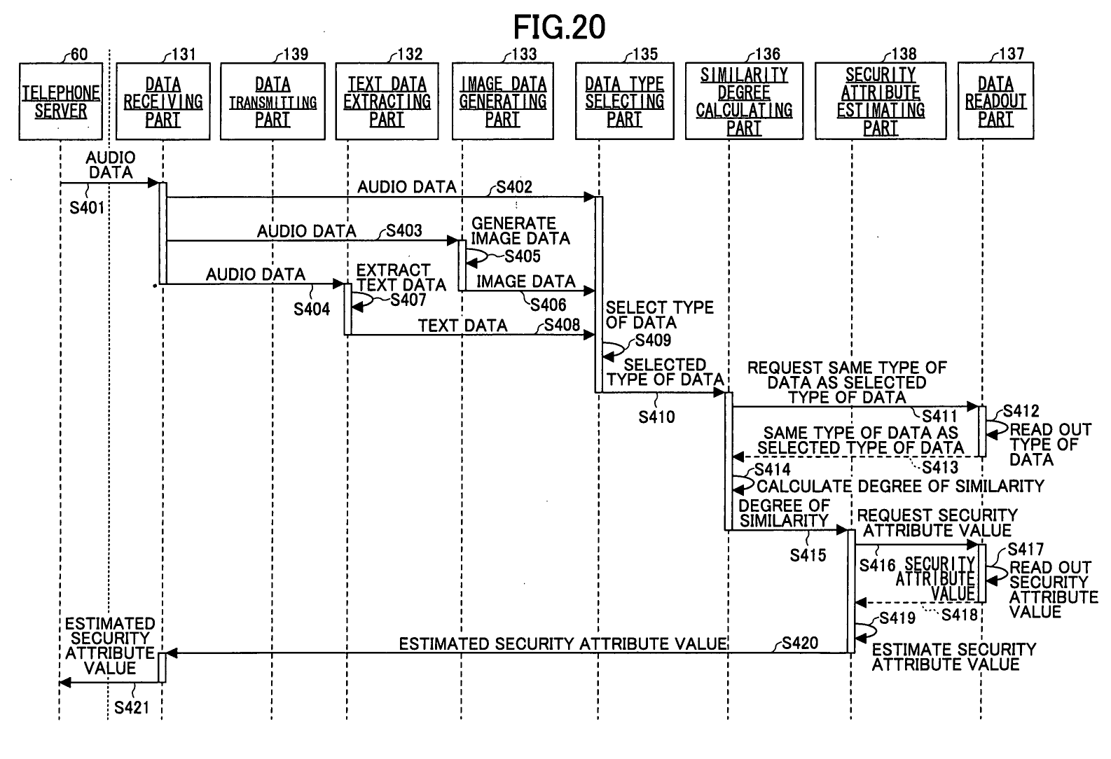

FIG. 20 is a sequence diagram for describing an operation of estimating the security attribute value of a target data item (undefined data item) according to the fourth embodiment of the present invention. In the fourth embodiment, the target data item (undefined data item) for estimating the security value is an audio data item transmitted from the audio server 60.

First, the audio server 60 transmits an audio data item from a telephone and a request for estimating the security attribute value of the audio data item to the security attribute estimating server 10 (Step S401). Then, the data receiving part 131 in the security attribute estimating server 10 outputs the received audio data item to the data type selecting part 135, the image data generating part 133, and the text data extracting part 132, respectively (Steps S402, S403, S404).

The image data generating part 133 and the text data extracting part 132 each generate a corresponding type of data from the received audio data. That is, the image data generating part 133 generates image data from the audio data item (Step S405) and outputs the image data to the data type selecting part (Step S406). The text data extracting part 132 generates text data from the audio data item (Step S407) and outputs the text data to the data type selecting part (Step S408).

It is, however, to be noted that plural types of data (e.g. image data, text data) does not have to be generated (processed) from the audio data item, but a single type of data may also be generated from the audio data item. In other words, the type of data to be generated (processed) in the security attribute estimating part 13 may be generated (processed) depending on the property of the audio data item (undefined data item).

Since the steps after Step S408 (i.e. S409-S421) are the same as those of Steps S132-S144 of FIG. 8, further description thereof is omitted.

In the security management system 4 according to the fourth embodiment of the present invention, an undefined audio data item (telephone conversation) being obtained from the telephone can be applied with a security attribute value of a registered data item including data that is identical or similar to the undefined audio data item. Accordingly, in a case where a telephone conversation containing data registered in a database is obtained from the telephone (telephone server), the security attribute value associated to the registered data is applied to the audio data of the telephone conversation. Furthermore, in a case where a telephone conversation containing data similar to the data registered in a database is obtained from a telephone (telephone server), the security attribute value associated to the registered data is applied to the audio data of the telephone conversation. Accordingly, the security for such telephone conversation (audio data) can be managed efficiently.

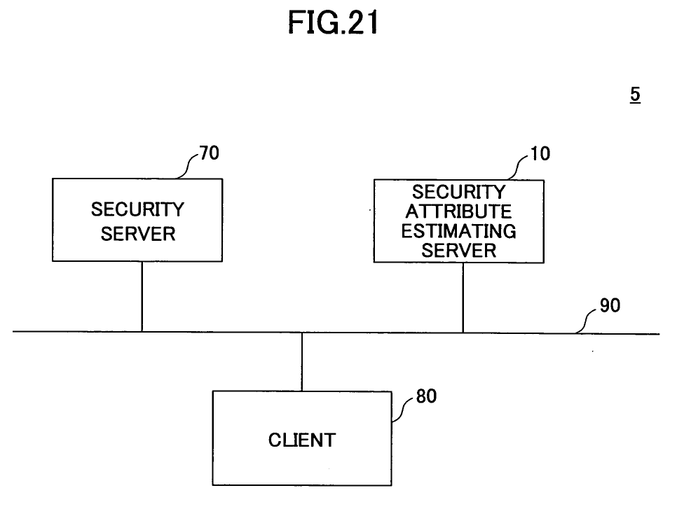

The above-described security attribute estimating server 10 of the first-fourth embodiments of the present invention may be applied to a security system shown in FIG. 21. FIG. 21 shows an exemplary configuration of a security system 5 including the security attribute estimating server 10 according to an embodiment of the present invention.

The security system 5 shown in FIG. 21 includes, for example, the security attribute estimating server 10, a security server 70, and a client 80 that are connected to each other by a network 90 (e.g. LAN or the Internet).

The security server 70 is a computer for controlling access based on security attribute values. More specifically, the security server 70 conducts access control based on a security policy (predetermined access control data) that is written in, for example, XACML (extensible Access Control Markup Language).

The client 80 is a computer (e.g. personal computer (PC)) that is used by the user for handling document files. The document files of the client 80 include data that are not associated to security attribute data (undefined data), for example, document data created by the user with word processing software or other data distributed from other users.

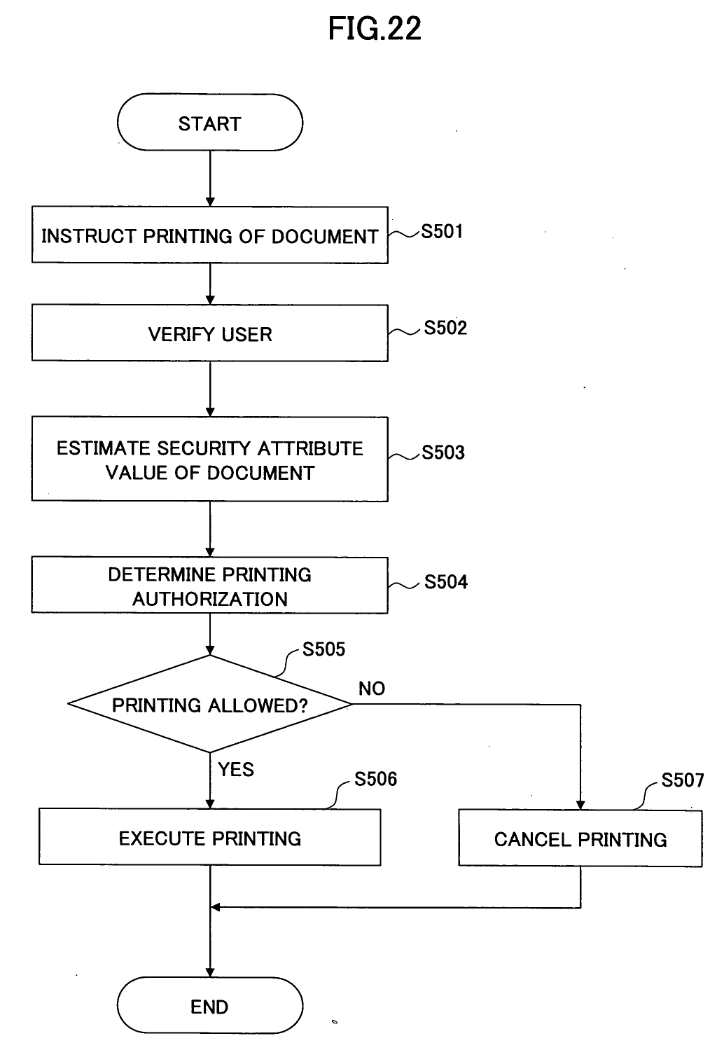

Next, an operation of the security system 5 is described with reference to FIG. 22. FIG. 22 is a flowchart showing an operation of the security system 5 in a case where printing of a document file is instructed.

First, in Step S501, the user instructs to print a document file (undefined data) to the client 80, the client 80 request the user to enter, for example, a user name and a password, and verifies the user based on the user name and the password (Step S502).

When the user is verified, the client 80 transmits the document file to the security attribute estimating server 10 and requests the security attribute estimating server to estimate the security attribute value of the document file. In response to the request from the client 80, the security attribute estimating server 10 estimates the security attribute value of the document file, and returns the estimation results (estimated security attribute value) to the client 80 (Step S503). The operation executed by the security attribute server is described in the first-fourth embodiments of the present invention.

Then, the client 80 transmits the security attribute value returned from the security attribute estimating server 10 to the security server 70, and requests the security server 70 to determine whether the printing of the document file is allowed. The security server 70 determines whether printing of the document file is allowed by referring to a security policy, and returns the determination results to the client 80 (Step S504). In a case where the determination results allow the printing of the document file (Yes in Step S505), the client 80 executes a printing operation (Step S506). In a case where the determination result does not allow the printing of the document file (No in Step S506), the client 80 cancels the printing operation (Step S507).

Accordingly, even in a case where the document file of the client 80 is not associated to a security attribute value, the security attribute estimating server 10 estimates a security attribute value to be applied to the document file by referring to registered data that is identical or similar to the data included in the document file and applying a security attribute value corresponding to the identical or similar registered data. Thereby, access of the document file can be efficiently controlled.

In one example, the determination of allowing printing (operating) of the document file by the security server 70 may differ based on whether the security attribute value of the document file is a security attribute value that is directly associated to the document file or a security attribute value that is obtained by estimating data identical or similar to the data of the document file. In this example, a security policy for the former and the latter may be provided.

In the above-described embodiments of the present invention, the term “security attribute value” not only includes security data (security value), but also may be document ID. This owes to the fact that security data (security value) of a target document can also be obtained by identifying the document ID of the target document. Furthermore, the security attribute estimating server 10, in addition to estimating the security attribute value to be applied to a target document, may also determine whether the target document is allowed to be operated (e.g. printed, transmitted) and transmit the determination results to, for example, a client.

Further, the present invention is not limited to these embodiments, but variations and modifications may be made without departing from the scope of the present invention.

The present application is based on Japanese Priority Application No. 2005-216004 filed on Jul. 26, 2005, with the Japanese Patent Office, the entire contents of which are hereby incorporated by reference.

What is claimed is:

1. A security value estimating apparatus for estimating a security value of an unregistered data item, the security value estimating apparatus comprising:
a primary data generating part for generating various types of primary data based on the unregistered data item;
a data amount calculating part for calculating the value of the data amount of each type of the primary data;
a similarity degree calculating part for calculating a degree of similarity of the primary data with respect to various types of secondary data that are generated based on a registered data item; and
a security value estimating part for estimating the security value of the unregistered data item by selecting a secondary data item from the secondary data based on the value of the data amount calculated by the data amount calculating part and the degree of similarity calculated by the similarity degree calculating part and applying the security value corresponding to the selected secondary data item.

2. The security value estimating apparatus as claimed in claim 1, wherein the data amount calculating part selects at least one of the secondary data items from the secondary data based on the value of the calculated data amount, wherein the similarity degree calculating part calculates the degree of similarity between the secondary data item selected by the data amount calculating part and the various types of secondary data.

3. The security value estimating apparatus as claimed in claim 2, wherein the data amount calculating part normalizes the calculated value of the data amount and selects the secondary data item based on the normalized value.

4. The security value estimating apparatus as claimed in claim 1, wherein the similarity degree calculating part calculates the degree of similarity for all of the various types of primary data generated by the primary data generating part.

5. The security value estimating apparatus as claimed in claim 4, wherein the similarity degree calculating part multiplies the calculated degrees of similarity with the value of the data amount.

6. The security value estimating apparatus as claimed in claim 1, wherein the security value estimating part estimates the security value of the unregistered data item by selecting a predetermined degree of similarity calculated by the similarity degree calculating part and applying the security value corresponding to the secondary data item of the selected degree of similarity.

7. The security value estimating apparatus as claimed in claim 1, wherein the security value estimating part estimates the security value of the unregistered data item by adding the degree of similarity for each type of secondary data, selecting one of the secondary data items from the secondary data based on the total of the added degree of similarity, and applying a security value corresponding to the selected secondary data item.

8. The security value estimating apparatus as claimed in claim 1, wherein the value of the data amount is the size of at least one of the primary data and the secondary data.

9. The security value estimating apparatus as claimed in claim 1, wherein the value of the data amount is a proportion of data size of at least one of the primary data and the secondary data.

10. The security value estimating apparatus as claimed in claim 1, wherein the value of the data amount is a value based on a scale indicative of the amount of data for each type of the primary data.

11. The security value estimating apparatus as claimed in claim 1, wherein the value of the data amount is a proportion of data amount.

12. The security value estimating apparatus as claimed in claim 1, further comprising:
a registered data obtaining part for obtaining the registered data item;
a secondary data generating part for generating the various types of secondary data based on the registered data item.

13. The security value estimating apparatus as claimed in claim 12, further comprising:
a data storing part for storing the secondary data generated by the secondary data generating part.

14. A security value estimating method for estimating a security value of an unregistered data item, the security value estimating method comprising the steps of:
a) generating various types of primary data based on the unregistered data item;
b) calculating the value of the data amount of each type of the primary data;
c) calculating the degree of similarity of the primary data with respect to various types of secondary data that are generated based on a registered data item; and
d) estimating the security value of the unregistered data item by selecting a secondary data item from the secondary data based on the value of the data amount calculated in step b) and the degree of similarity calculated in step c) and applying the security value corresponding to the selected secondary data item.

15. The security value estimating method as claimed in claim 14, wherein step b) includes a step of selecting at least one of the secondary data items from the secondary data based on the value of the calculated data amount, wherein step c) includes a step of calculating the degree of similarity between the secondary data item selected in step b) and the various types of secondary data.

16. The security value estimating method as claimed in claim 15, wherein step b) includes a step of normalizing the calculated value of the data amount and selecting the secondary data item based on the normalized value.

17. The security value estimating method as claimed in claim 14, wherein step c) includes a step of calculating the degree of similarity for all of the various types of primary data generated in step a).

18. The security value estimating method as claimed in claim 17, wherein step c) includes a step of multiplying the calculated degrees of similarity with the value of the data amount.

19. The security value estimating method as claimed in claim 14, wherein step d) includes a step of estimating the security value of the unregistered data item by selecting a predetermined degree of similarity calculated in step c) and applying the security value corresponding to the secondary data item of the selected degree of similarity.

20. A computer-readable recording medium on which a program is recorded for causing a computer to execute a security value estimating method for estimating a security value of an unregistered data item, the security value estimating method comprising the steps of:
a) generating various types of primary data based on the unregistered data item;
b) calculating the value of the data amount of each type of the primary data;
c) calculating the degree of similarity of the primary data with respect to various types of secondary data that are generated based on a registered data item; and
d) estimating the security value of the unregistered data item by selecting a secondary data item from the secondary data based on the value of the data amount calculated in step b) and the degree of similarity calculated in step c) and applying the security value corresponding to the selected secondary data item.
